(19) United States
(12) Patent Application Publication
(10) Pub. No.: US 2016/0232715 A1
(43) Pub. Date: Aug. 11, 2016

(54) VIRTUAL REALITY AND AUGMENTED REALITY CONTROL WITH MOBILE DEVICES

(71) Applicant: Fangwei Lee, San Carlos, CA (US)

(72) Inventor: Fangwei Lee, San Carlos, CA (US)

(21) Appl. No.: 15/087,131

(22) Filed: Mar. 31, 2016

Related U.S. Application Data
(63) Continuation-in-part of application No. 14/745,414, filed on Jun. 20, 2015.
(60) Provisional application No. 62/114,417, filed on Feb. 10, 2015.

(51) Int. Cl. G06T 19/00; G02B 27/01; G06K 9/62; G06F 3/01; G06T 7/00

(52) U.S. Cl. CPC G06T 19/006; G06F 3/011; G06F 3/017; G06T 7/004; G06K 9/6202; G02B 27/0172; G06T 2207/30204; G02B 2027/0178; G02B 2027/014; G02B 2027/0138

(57) ABSTRACT

Systems and methods for generating an action in a virtual reality or augmented reality environment based on position or movement of a mobile device in the real world are disclosed. A particular embodiment includes: displaying an optical marker on a display device of a motion-tracking controller; receiving a set of reference data from the motion-tracking controller; receiving captured marker image data from an image capturing subsystem of an eyewear system; comparing reference marker image data with the captured marker image data, the reference marker image data corresponding to the optical marker; generating a transformation matrix using the reference marker image data and the captured marker image data, the transformation matrix corresponding to a position and orientation of the motion-tracking controller relative to the eyewear system; and generating an action in a virtual world, the action corresponding to the transformation matrix.

### PRIORITY PATENT APPLICATIONS

This is a continuation-in-part patent application of U.S. patent application Ser. No. 14/745,414; filed Jun. 20, 2015 by the same applicant, which is a non-provisional patent application drawing priority from U.S. provisional patent application Ser. No. 62/114,417; filed Feb. 10, 2015. This present patent application draws priority from the referenced patent applications. The entire disclosure of the referenced patent applications is considered part of the disclosure of the present application and is hereby incorporated by reference herein in its entirety.

### BACKGROUND

1. Technical Field

The present disclosure generally relates to virtual reality systems and methods. More specifically, the present disclosure relates to systems and methods for generating an action in a virtual reality or augmented reality environment based on position or movement of a mobile device in the real world.

2. Related Art

With the proliferation in consumer electronics, there has been a renewed focus on wearable technology, which encompasses innovations such as wearable computers or devices incorporating either augmented reality (AR) or virtual reality (VR) technologies. Both AR and VR technologies involve computer-generated environments that provide entirely new ways for consumers to experience content. In augmented reality, a computer-generated environment is superimposed over the real world (for example, in Google Glass™). Conversely, in virtual reality, the user is immersed in the computer-generated environment (for example, via a virtual reality headset such as the Oculus Rift™).

Existing AR and VR devices, however, have several shortcomings. For example, AR devices are usually limited to displaying information, and may not have the capability to detect real-world physical inputs (such as a user's hand gestures or motion). The VR devices, on the other hand, are often bulky and require electrical wires connected to a power source. In particular, the wires can constrain user mobility and negatively impact the user's virtual reality experience.

### SUMMARY

The example embodiments address at least the above deficiencies in existing augmented reality and virtual reality devices. In various example embodiments, a system and method for virtual reality and augmented reality control with mobile devices is disclosed. Specifically, the example embodiments disclose a portable cordless optical input system and method for converting a physical input from a user into an action in an augmented reality or virtual reality environment, where the system can also enable real-life avatar control.

An example system in accordance with the example embodiments includes a tracking device, a user device, an image capturing device, and a data converter coupled to the user device and the image capturing device. In one particular embodiment, the image capturing device obtains images of a first marker and a second marker on a tracking device. The data converter determines reference positions of the first marker and the second marker at time t0 using the obtained images, and measures a change in spatial relation of/between the first marker and the second marker at time t1, whereby the change is generated by a user input on the tracking device. The time t1 is a point in time that is later than time t0. The data converter also determines whether the change in spatial relation of/between the first marker and the second marker at time t1 falls within a predetermined threshold range, and generates an action in a virtual world on the user device if the change in spatial relation falls within the predetermined threshold range.

In some embodiments, the image capturing device may be configured to obtain reference images of a plurality of markers on a tracking device, and track the device based on the obtained images. In other embodiments described herein, we define the reference image or images to be a part or portion of a broader set of reference data that can be used to determine a change in spatial relation. In an example embodiment, the reference data can include: 1) data from the use of a plurality of markers with one or more of the markers being a reference image (e.g., a portion of the reference data); 2) data from the use of one marker with images of the marker sampled at multiple instances of time, one or more of the image samples being a reference image (e.g., another portion of the reference data); 3) position/orientation data of an image capturing device (e.g., another portion of the reference data), the change in spatial relation being relative to the position/orientation data of the image capturing device; and 4) position/orientation data of a tracking device (e.g., another portion of the reference data), the change in spatial relation being relative to the position/orientation data of the tracking device. It will be apparent to those of ordinary skill in the art in view of the disclosure herein that the reference data can include other data components that can be used in determining a change in spatial relation.

In some embodiments, actions in the virtual world may be generated based on the observable presence of the markers. In those embodiments, the disappearance and/or reappearance of individual markers between times t0 and t1 may result in certain actions being generated in the virtual world.

Embodiments of a method in accordance with the example embodiments include obtaining images of a first marker and a second marker on a tracking device, determining reference positions of the first marker and the second marker at time t0 using the obtained images, measuring a change in spatial relation of/between the first marker and the second marker at time t1 whereby the change is generated by a user input on the tracking device, determining whether the change in spatial relation of/between the first marker and the second marker at time t1 falls within a threshold range, and generating an action in a virtual world on the user device if the change in spatial relation falls within the predetermined threshold range.

Other aspects and advantages of the example embodiments will become apparent from the following detailed description taken in conjunction with the accompanying drawings which illustrate, by way of example, the principles of the example embodiments.

### BRIEF DESCRIPTION OF THE DRAWINGS

For a better understanding of the example embodiments, reference should be made to the following detailed description taken in conjunction with the accompanying drawings, in which:

FIG. 1 illustrates a block diagram of an example system consistent with the example embodiments;

FIGS. 2, 3, 4, 5, 6, 7, 8, and 9 illustrate a user device in accordance with different embodiments;

FIGS. 10, 11, and 12 depict different perspective views of a tracking device in accordance with an embodiment;

FIG. 13 illustrates a plan view of an example rig prior to its assembly;

FIGS. 14 and 15 illustrate example patterns for the first marker and the second marker of FIGS. 10, 11, and 12;

FIGS. 16, 17, and 18 illustrate operation of an example system by a user;

FIGS. 19 and 20 illustrate example actions generated in a virtual world, the actions corresponding to different physical inputs from the user;

FIGS. 21, 22, 23, 24, and 25 illustrate the spatial range of physical inputs available on an example tracking device;

FIGS. 26 and 27 illustrate an example system in which a single image capturing device is used;

FIG. 28 illustrates the field-of-view of the image capturing device of FIG. 27;

FIG. 29 illustrates the increase in field-of-view when a modifier lens is attached to the image capturing device of FIGS. 27 and 28;

FIGS. 30, 31, and 32 illustrate example systems in which multiple users are connected in a same virtual world;

FIGS. 33, 34, 35, 36, 37, 38, and 39 illustrate example actions generated in a virtual world according to different embodiments;

FIG. 40 illustrates an example system using one marker to track the user's hand in the virtual world;

FIG. 41 depicts a variety of configurations of markers in various embodiments;

FIG. 42 illustrates an example embodiment with character navigation implemented with an accelerometer or pedometer;

FIGS. 43 and 44 depict an embodiment in which the optical markers are attached to a game controller;

FIG. 45 depicts an embodiment in which the direction control buttons and action buttons are integrated onto a tracking device;

FIG. 46 is a flow chart illustrating an example method for converting a physical input from a user into an action in a virtual world;

FIG. 47 is a processing flow chart illustrating an example embodiment of a method as described herein;

FIGS. 48 and 49 illustrate an example embodiment of a universal motion-tracking controller (denoted herein a SmartController) in combination with digital eyewear to measure the positional, rotational, directional, and movement data of its users and their corresponding body gestures and movements;

FIGS. 50 through 52 illustrate how an example embodiment can estimate the position of the SmartController using the acceleration data, orientation data, and the anatomical range of the human locomotion;

FIG. 53 illustrates an example embodiment in which the SmartController can couple with external cameras to increase the coverage area where the SmartController is tracked;

FIG. 54 illustrates an example embodiment in which the SmartController can be coupled with an external camera and used to control external machines or displays;

FIG. 55 illustrates a variety of methods that can be used to provide user input via the SmartController;

FIG. 56 is a processing flow chart illustrating an example embodiment of a method as described herein; and

FIG. 57 shows a diagrammatic representation of a machine in the example form of a mobile computing and/or communication system within which a set of instructions when executed and/or processing logic when activated may cause the machine to perform any one or more of the methodologies described and/or claimed herein.

### DETAILED DESCRIPTION

Reference will now be made in detail to the example embodiments illustrated in the accompanying drawings. Wherever possible, the same reference numbers will be used throughout the drawings to refer to the same or like parts.

Methods and systems disclosed herein address the above described needs. For example, methods and systems disclosed herein can convert a physical input from a user into an action in a virtual world. The methods and systems can be implemented on low power mobile devices and/or three-dimensional (3D) display devices. The methods and systems can also enable real-life avatar control. The virtual world may include a visual environment provided to the user, and may be based on either augmented reality or virtual reality.

In one embodiment, a cordless portable input system for mobile devices is provided. A user can use the system to: (1) input precise and high resolution position and orientation data; (2) invoke analog actions (e.g., pedaling or grabbing) with realistic one-to-one feedback; (3) use multiple interaction modes to perform a variety of tasks in a virtual world or control a real-life avatar (e.g., a robot); and/or (4) receive tactile feedback based on actions in the virtual world.

The system is lightweight and low cost, and therefore ideal as a portable virtual reality system. The system can also be used as a recyclable user device in a multi-user environment such as a theater. The system employs a tracking device with multiple image markers as an input mechanism. The markers can be tracked using a camera on the mobile device to obtain position and orientation data for a pointer in a virtual reality world. The system can be used in various fields including the gaming, medical, construction, or military fields.

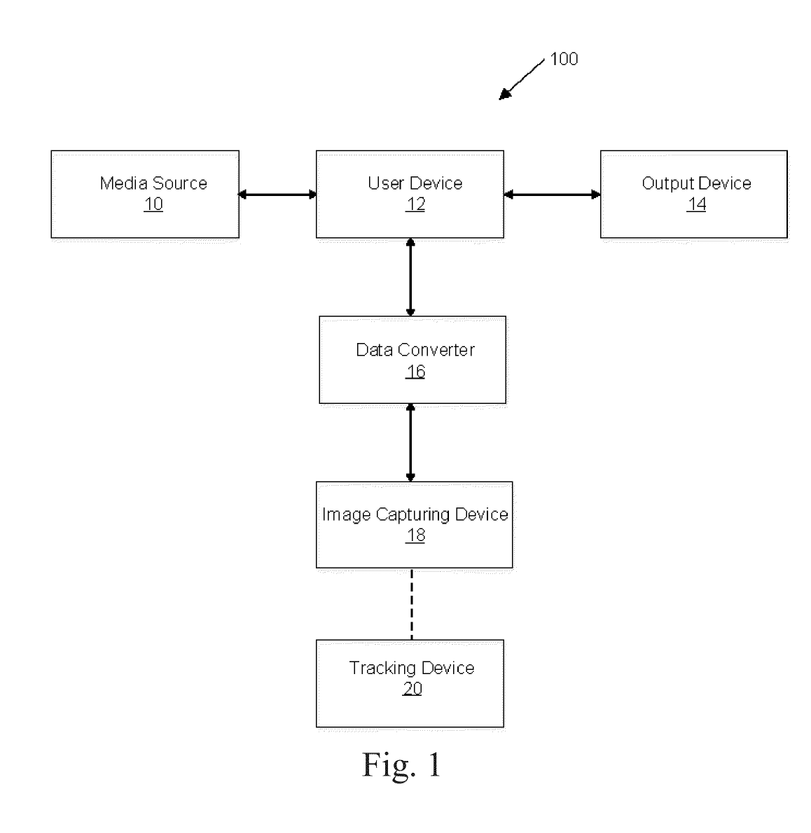

FIG. 1 illustrates a block diagram of an example system 100 consistent with the example embodiments. As shown in FIG. 1, system 100 may include a media source 10, a user device 12, an output device 14, a data converter 16, an image capturing device 18, and a tracking device 20. Each of the components 10, 12, 14, 16, and 18 is operatively connected to one another via a network or any type of communication links that allow transmission of data from one component to another. The network may include Local Area Networks (LANs), Wide Area Networks (WANs), Bluetooth, and/or Near Field Communication (NFC) technologies, and may be wireless, wired, or a combination thereof. Media source 10 can be any type of storage medium capable of storing imaging data, such as video or still images. The video or still images may be displayed in a virtual world rendered on the output device 14. For example, media source 10 can be provided as a CD, DVD, Blu-ray disc, hard disk, magnetic tape, flash memory card/drive, solid state drive, volatile or non-volatile memory, holographic data storage, and any other type of storage medium. Media source 10 can also be a computer capable of providing imaging data to user device 12.

As another example, media source 10 can be a web server, an enterprise server, or any other type of computer server. Media source 10 can be computer programmed to accept requests (e.g., HTTP, or other protocols that can initiate data transmission) from user device 12 and to serve user device 12 with requested imaging data. In addition, media source 10 can be a broadcasting facility, such as free-to-air, cable, satellite, and other broadcasting facility, for distributing imaging data. The media source 10 may also be a server in a data network (e.g., a cloud computing network).

User device 12 can be, for example, a virtual reality headset, a head mounted device (HMD), a cell phone or smartphone, a personal digital assistant (PDA), a computer, a laptop, a tablet personal computer (PC), a media content player, a video game station/system, or any electronic device capable of providing or rendering imaging data. User device 12 may include software applications that allow user device 12 to communicate with and receive imaging data from a network or local storage medium. As mentioned above, user device 12 can receive data from media source 10, examples of which are provided above.

As another example, user device 12 can be a web server, an enterprise server, or any other type of computer server. User device 12 can be a computer programmed to accept requests (e.g., HTTP, or other protocols that can initiate data transmission) for converting a physical input from a user into an action in a virtual world, and to provide the action in the virtual world generated by data converter 16. In some embodiments, user device 12 can be a broadcasting facility, such as free-to-air, cable, satellite, and other broadcasting facility, for distributing imaging data, including imaging data in a 3D format in a virtual world.

In the example of FIG. 1, data converter 16 can be implemented as a software program executed by a processor and/or as hardware that converts analog data to an action in a virtual world based on physical input from a user. The action in the virtual world can be depicted in one of video frames or still images in a 2D or 3D format, can be real-life and/or animated, can be in color, black/white, or grayscale, and can be in any color space.

Output device 14 can be a display device such as, for example, a display panel, monitor, television, projector, or any other display device. In some embodiments, output device 14 can be, for example, a cell phone or smartphone, personal digital assistant (PDA), computer, laptop, desktop, a tablet PC, media content player, set-top box, television set including a broadcast tuner, video game station/system, or any electronic device capable of accessing a data network and/or receiving imaging data.

Image capturing device 18 can be, for example, a physical imaging device such as a camera. In one embodiment, the image capturing device 18 may be a camera on a mobile device. Image capturing device 18 can be configured to capture imaging data relating to tracking device 20. The imaging data may correspond to, for example, still images or video frames of marker patterns on tracking device 20. Image capturing device 18 can provide the captured imaging data to data converter 16 for data processing/conversion, so as to generate an action in a virtual world on user device 12.

In some embodiments, image capturing device 18 may extend beyond a physical imaging device. For example, image capturing device 18 may include any technique that is capable of capturing and/or generating images of marker patterns on tracking device 20. In some embodiments, image capturing device 18 may refer to an algorithm that is capable of processing images obtained from another physical device.

While shown in FIG. 1 as separate components that are operatively connected, any or all of media source 10, user device 12, output device 14, data converter 16, and image capturing device 18 may be co-located in one device. For example, media source 10 can be located within or form part of user device 12 or output device 14, output device 14 can be located within or form part of user device 12, data converter 16 can be located within or form part of media source 10, user device 12, output device 14, or image capturing device, and image capturing device 18 can be located within or form part of user device 12 or output device 14. It is understood that the configuration shown in FIG. 1 is for illustrative purposes only. Certain components or devices may be removed or combined and other components or devices may be added.

In the embodiment of FIG. 1, tracking device 20 may be any physical object or structure that can be optically tracked in real-time by image capturing device 18. The tracking device 20 may include, for example, unique marker patterns that can be easily detected in an image captured by image capturing device 18. By using easily detectable marker patterns, complex and computationally expensive image processing can be avoided. Optical tracking has several advantages. For example, optical tracking allows for wireless ‘sensors’, is less susceptible to noise, and allows for many objects (e.g., various marker patterns) to be tracked simultaneously.

The interaction between image capturing device 18 and tracking device 20 is through a visual path (denoted by the dotted line in FIG. 1). It is noted that tracking device 20 is not operatively connected to any of the other components in FIG. 1. Instead, tracking device 20 is a stand-alone physical object or structure that is operable by a user. For example, tracking device 20 may be held by or attached to a user's hand/arm in a manner that allows the tracking device 20 to be optically tracked by image capturing device 18. In some embodiments, the tracking device 20 may be configured to provide tactile feedback to the user, whereby the tactile feedback is based on an analog input received from the user. The analog input may correspond to, for example, a translation or rotation of optical markers on the tracking device 20. Any type, range, and magnitude of motion is contemplated.

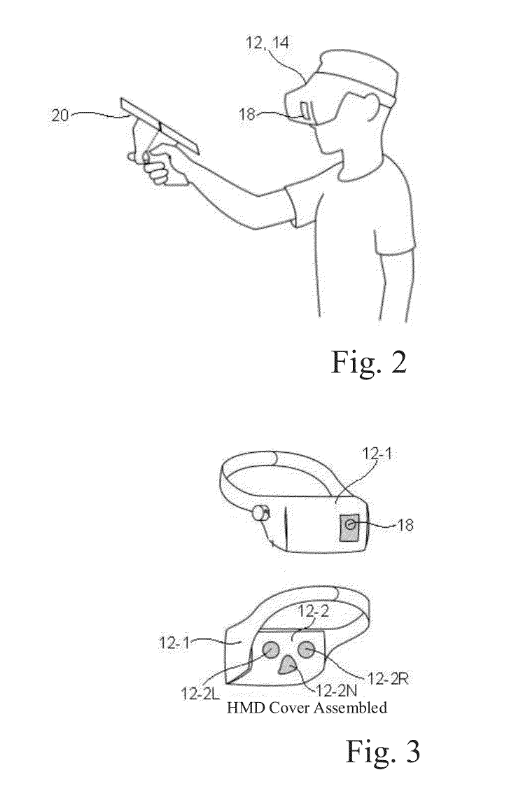

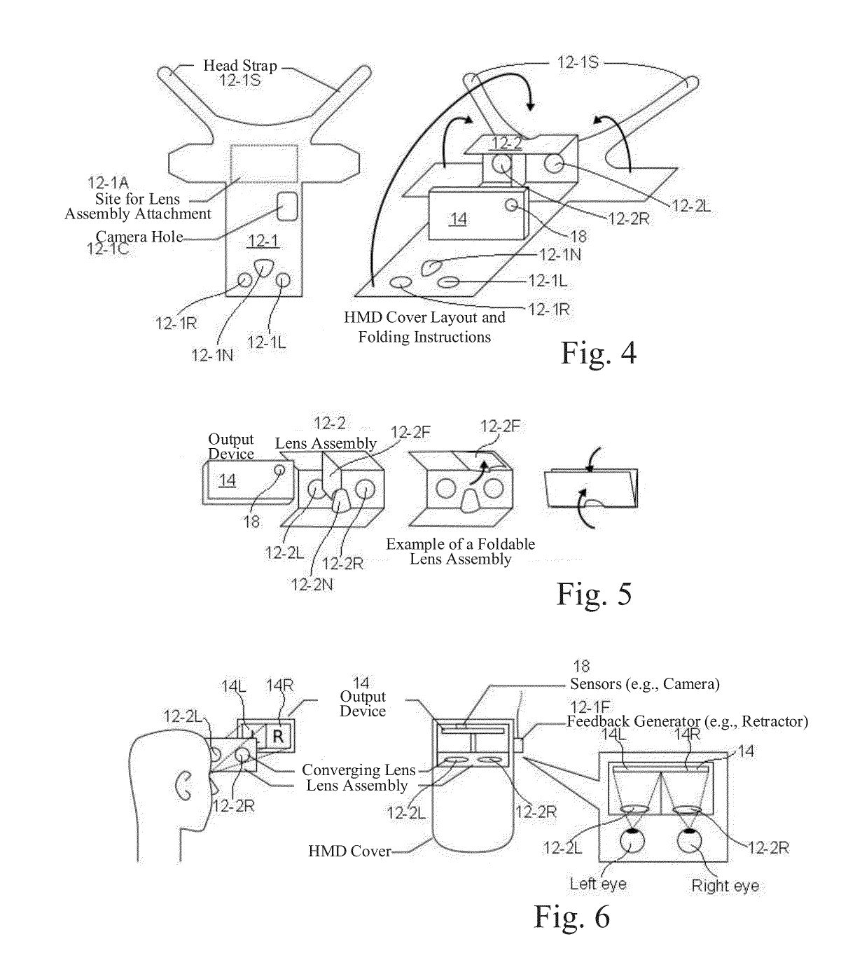

Next, the user device 20 in accordance with an embodiment will be described with reference to FIGS. 2, 3, 4, 5, and 6. Referring to FIG. 2, the user device 12 is provided in the form of a virtual reality head mounted device (HMD). FIG. 2 illustrates a user wearing the user device 12 and operating the tracking device 20 in one hand. FIG. 3 illustrates different perspective views of the user device 12 in an assembled state. The user device 12 includes a HMD cover 12-1, a lens assembly 12-2, the output device 14 (not shown), and the image capturing device 18. As previously mentioned, the user device 12, output device 14, and image capturing device 18 may be co-located in one device (for the example, the virtual HMD of FIGS. 2 and 3). The components in the user device 12 of FIG. 3 will be described in more detail with reference to FIGS. 4, 5, and 6. Specifically, FIGS. 4 and 5 illustrate the user device 12 in a pre-assembled state, and FIG. 6 illustrates the operation of the user device 12 by a user. In the embodiment of FIGS. 2 through 6, the image capturing device 18 is located on the output device 14.

Referring to FIGS. 4, 5, and 6, the HMD cover 12-1 includes a head strap 12-1S for mounting the user device 12 to the user's head, a site 12-1A for attaching the lens assembly 12-2, a hole 12-1C for exposing the lenses of the image capturing device 18, a left eye hole 12-1L for the user's left eye, a right eye hole 12-1R for the user's right eye, and a hole 12-1N to seat the user's nose. The HMD cover 12-1 may be made of various materials such as foam rubber, Neoprene™ cloth, etc. The foam rubber may include, for example, a foam sheet made of Ethylene Vinyl Acetate (EVA).

The lens assembly 12-2 is configured to hold the output device 14. An image displayed on the output device 14 may be partitioned into a left eye image 14L and a right eye image 14R. The image displayed on the output device 14 may be an image of a virtual reality or an augmented reality world. The lens assembly 12-2 includes a left eye lens 12-2L for focusing the left eye image 14L for the user's left eye, a right eye lens 12-2R for focusing the right eye image 14R for the user's right eye, and a hole 12-2N to seat the user's nose. The left and right eye lenses 12-2L and 12-2R may include any type of optical focusing lenses, for example, convex or concave lenses. When the user looks through the left and right eye holes 12-1L and 12-1R, the user's left eye will see the left eye image 14L (as focused by the left eye lens 12-2L), and the user's right eye will see the right eye image 14R (as focused by the right eye lens 12-2R).

In some embodiments, the user device 12 may further include a toggle button (not shown) for controlling images generated on the output device 14. As previously mentioned, the media source 10 and data converter 16 may be located either within, or remote from, the user device 12.

To assemble the user device 12, the output device 14 (including the image capturing device 18) and the lens assembly 12-2 are first placed on the HMD cover 12-1 in their designated locations. The HMD cover 12-1 is then folded in the manner as shown on the right of FIG. 4. Specifically, the HMD cover 12-1 is folded so that the left and right eye holes 12-1L and 12-1R align with the respective left and right eye lenses 12-2L and 12-2R, the hole 12-1N aligns with the hole 12-2N, and the hole 12-1C exposes the lenses of the image capturing device 18. One head strap 12-1S can also be attached to the other head strap 12-1S (using, for example, Velcro™ buttons, binders, etc.) so as to mount the user device 12 onto the user's head.

In some embodiments, the lens assembly 12-2 may be provided as a foldable lens assembly, for example as shown in FIG. 5. In those embodiments, when the user device 12 is not in use, a user can detach the lens assembly 12-2 from the HMD cover 12-1, and further remove the output device 14 from the lens assembly 12-2. Subsequently, the user can lift up flap 12-2F and fold the lens assembly 12-2 into a flattened two-dimensional shape for easy storage. Likewise, the HMD cover 12-1 can also be folded into a flattened two-dimensional shape for easy storage. Accordingly, the HMD cover 12-1 and the lens assembly 12-2 can be made relatively compact to fit into a pocket, purse or any kind of personal bag, together with the output device 14 and image capturing device 18 (which may be provided in a smartphone). As such, the user device 12 is highly portable and can be carried around easily. In addition, by making the HMD cover 12-1 detachable, users can swap and use a variety of HMD covers 12-1 having different customized design patterns (similar to the swapping of different protective covers for mobile phones). Furthermore, since the HMD cover 12-1 is detachable, it can be cleaned easily or recycled after use.

In some embodiments, the user device 12 may include a feedback generator 12-1F that couples the user device 12 to the tracking device 20. Specifically, the feedback generator 12-1F may be used in conjunction with different tactile feedback mechanisms to provide tactile feedback to a user as the user operates the user device 12 and tracking device 20.

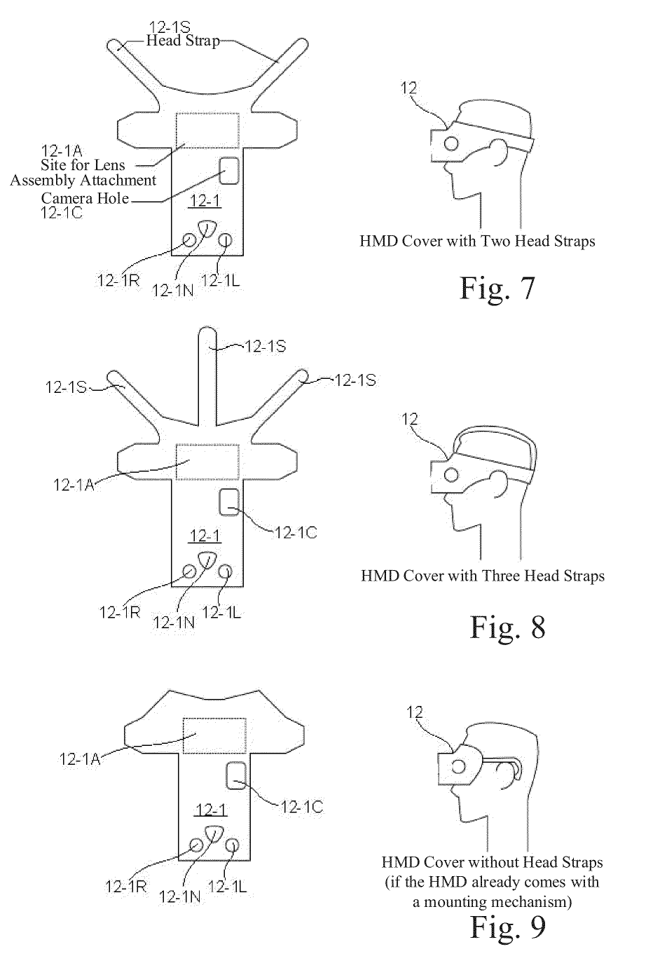

It is further noted that the HMD cover 12-1 can be provided with different numbers of head straps 12-1S. In some embodiments, the HMD cover 12-1 may include two head straps 12-1S (see, e.g., FIG. 7). In other embodiments, the HMD cover 12-1 may include three head straps 12-15 (see, e.g., FIG. 8) so as to more securely mount the user device 12 to the user's head. Any number of head straps is contemplated. In some alternative embodiments, the HMD cover 12-1 need not have a head strap, if the virtual reality HMD already comes with a mounting mechanism (see, e.g., FIG. 9). In an example embodiment to ensure users can experience VR with their full body, a head mounting rig can be fabricated out of a sheet of elastic material to mount the VR viewer on user's head with comfort.

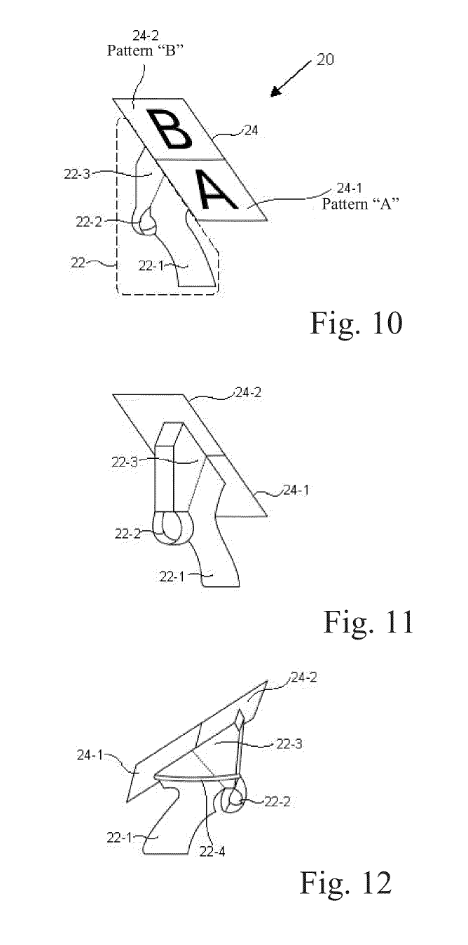

FIGS. 10, 11, and 12 depict different perspective views of a tracking device in accordance with an embodiment. Referring to FIG. 10, a tracking device 20 includes a rig 22 and optical markers 24. The tracking device 20 is designed to hold multiple optical markers 24 and to change their spatial relationship when a user provides a physical input to the tracking device 20 (e.g., through pushing, pulling, bending, rotating, etc.). The rig 22 includes a handle 22-1, a trigger 22-2, and a marker holder 22-3. The handle 22-1 may be ergonomically designed to fit a user's hand so that the user can hold the rig 22 comfortably. The trigger 22-2 is placed at a location so that the user can slide a finger (e.g., index finger) into the hole of the trigger 22-2 when holding the handle 22-1. The marker holder 22-3 serves as a base for holding the optical markers 24. In one embodiment, the rig 22 and the optical markers 24 are formed separately, and subsequently assembled together by attaching the optical markers 24 to the marker holder 22-3. The optical markers 24 may be attached to the marker holder 22-3 using any means for attachment, such as Velcro™, glue, adhesive tape, staples, screws, bolts, plastic snapfits, dovetail mechanisms, etc.

The optical markers 24 include a first marker 24-1 comprising an optical pattern “A” and a second marker 24-2 comprising an optical pattern “B”. Optical patterns “A” and “B” may be unique patterns that can be easily imaged and tracked by image capturing device 18. Specifically, when a user is holding the tracking device 20, the image capturing device 18 can track at least one of the optical markers 24 to obtain a position and orientation of the user's hand in the real world. In addition, the spatial relationship between the optical markers 24 provides an analog value that can be mapped to different actions in the virtual world.

Although two optical markers 24 have been illustrated in the example of FIGS. 10, 11, and 12, it should be noted that the example embodiments are not only limited to only two optical markers. For example, in other embodiments, the tracking device 20 may include three or more optical markers 24. In an alternative embodiment, the tracking device 20 may consist of only one optical marker 24.

Referring to FIG. 12, the tracking device 20 further includes an actuation mechanism 22-4 for manipulating the optical markers 24. Specifically, the actuation mechanism 22-4 can move the optical markers 24 relative to each other so as to change the spatial relation between the optical markers 24 (e.g., through translation, rotation, etc.), as described in further detail in the specification.

In the example of FIG. 12, the actuation mechanism 22-4 is provided in the form of a rubber band attached to various points on the rig 22. When a user presses the trigger 22-2 with his finger, the actuation mechanism 22-4 moves the second marker 24-2 to a new position relative to the first marker 24-1. When the user releases the trigger 22-2, the second marker 24-2 moves back to its original position due to the elasticity of the rubber band. In particular, rubber bands providing a range of elasticity can be used, so as to provide adequate tension (hence, tactile feedback to the user) under a variety of conditions when the user presses and releases the trigger 22-2. Different embodiments for providing tactile feedback will be described in more detail later in the specification with reference to FIGS. 43, 44, 45, and 17D.

Although a rubber band actuation mechanism has been described above, it should be noted that the actuation mechanism 22-4 is not limited to a rubber band. The actuation mechanism 22-4 may include any mechanism capable of moving the optical markers 24 relative to each other on the rig 22. In some embodiments, the actuation mechanism 22-4 may be, for example, a spring-loaded mechanism, an air-piston mechanism (driven by air pressure), a battery-operated motorized device, etc.

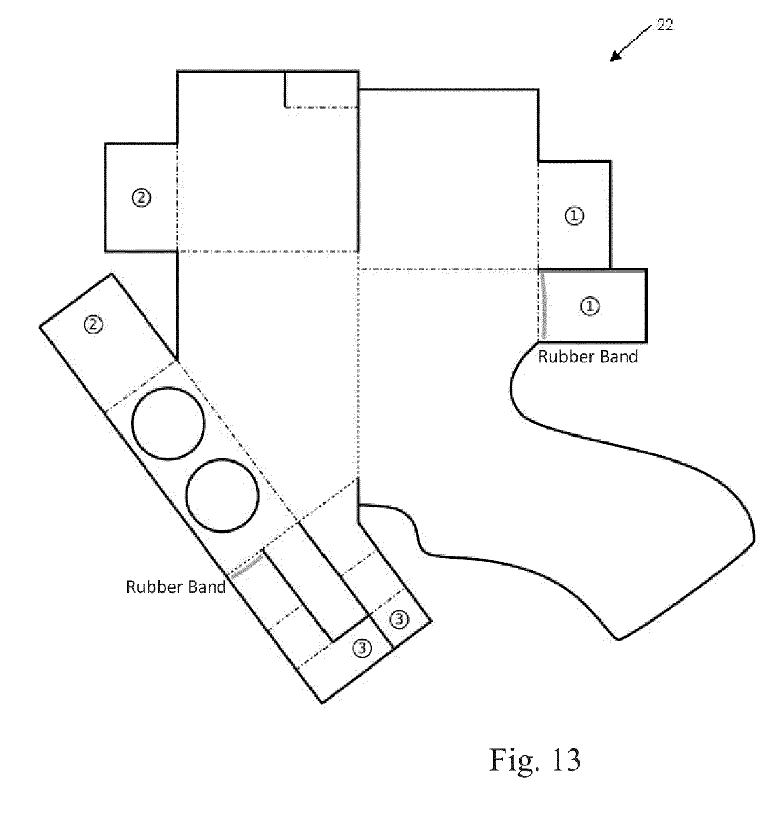

FIG. 13 illustrates a two-dimensional view of an example rig prior to its assembly. In the example of FIGS. 10, 11, and 12, the rig 22 may be made of cardboard. First, a two-dimensional layout of the rig 22 (shown in FIG. 13) is formed on a sheet of cardboard, and then folded along its dotted lines to form the three-dimensional rig 22. The actuation mechanism 22-4 (rubber band) is then attached to the areas denoted “rubber band.” To improve durability and to withstand heavy use, the rig 22 may be made of stronger materials such as wood, plastic, metal, etc.

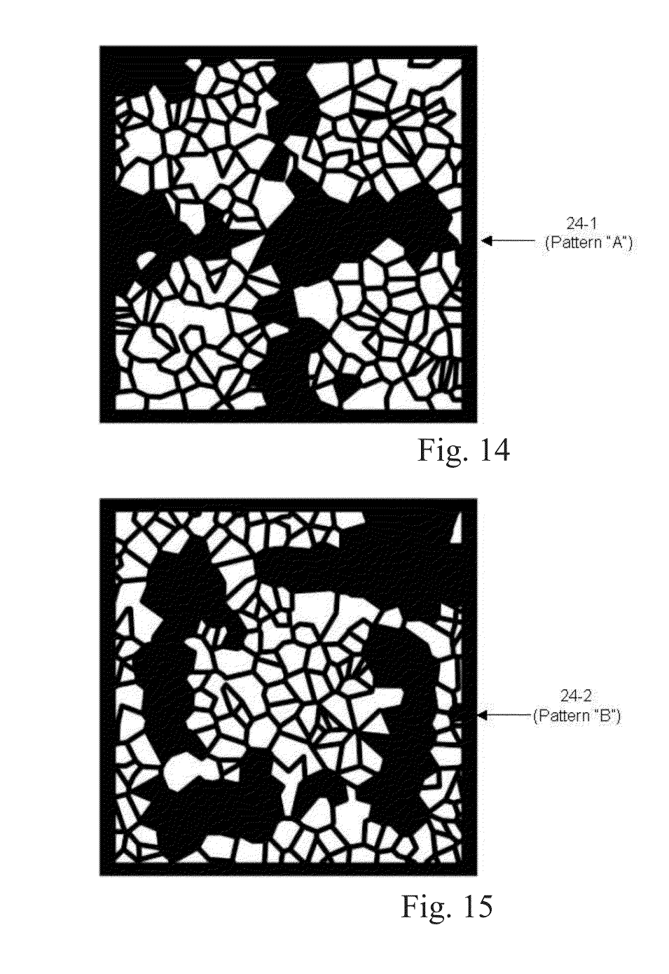

FIGS. 14 and 15 illustrate example patterns for the optical markers. Specifically, FIG. 14 illustrates an optical pattern “A” for the first marker 24-1, and FIG. 15 illustrates an optical pattern “B” for the second marker 24-2. As previously mentioned, optical patterns “A” and “B” are unique patterns that can be readily imaged and tracked by image capturing device 18. The optical patterns “A” and “B” may be black-and-white patterns or color patterns. To form the optical markers 24, the optical patterns “A” and “B” can be printed on a white paper card using, for example, an inkjet or laser printer, and attached to the marker holder 22-3. In those embodiments in which the optical patterns “A” and “B” are color patterns, the color patterns may be formed by printing, on the white paper card, materials that reflect/emit different wavelengths of light, and the image capturing device 18 may be configured to detect the different wavelengths of light. The optical markers 24 in FIGS. 14 and 15 have been found to generally work well in illuminated environments. However, the optical markers 24 can be modified for low-light and dark environments by using other materials such as glow-in-the-dark materials (e.g., diphenyl oxalate—Cyalume™), light-emitting diodes (LEDs), thermally sensitive materials (detectable by infrared cameras), etc. Accordingly, the optical markers 24 can be used to detect light that is in the invisible range (for example, infrared and/or ultraviolet), through the use of special materials and techniques (for example, thermal imaging).

It should be noted that the optical markers 24 are not merely limited to two-dimensional cards. In some other embodiments, the optical markers 24 may be three-dimensional objects. Generally, the optical markers 24 may include any object having one or more recognizable structures or patterns. Also, any shape or size of the optical markers 24 is contemplated.

In the embodiments of FIGS. 14 and 15, the optical markers 24 passively reflect light. However, the example embodiments are not limited thereto. In some other embodiments, the optical markers 24 may also actively emit light, for example, by using a light emitting diode (LED) panel for the optical markers 24.

In some embodiments, when the tracking device 20 is not in use, the user can detach the optical markers 24 from the marker holder 22-3 and fold the rig 22 back into a flattened two-dimensional shape for easy storage. The folded rig 22 and optical markers 24 can be made relatively compact to fit into a pocket, purse or any kind of personal bag. As such, the tracking device 20 is highly portable and can be carried around easily with the user device 12. In some embodiments, the tracking device 20 and the user device 12 can be folded together to maximize portability.

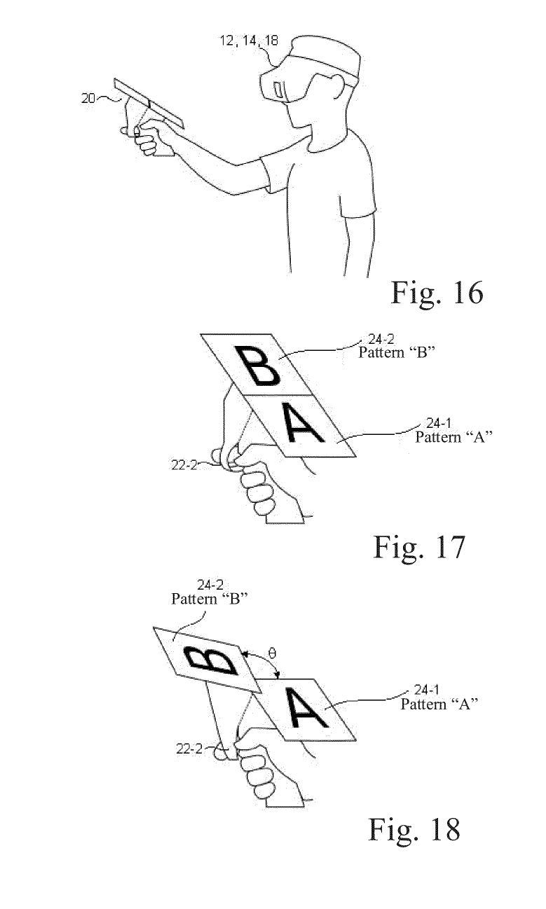

FIGS. 16, 17, and 18 illustrate operation of an example system by a user. Referring to FIG. 16, the user device 12 is provided in the form of a virtual reality head mounted device (HMD), with the output device 14 and image capturing device 18 incorporated into the user device 12. The user device 12 may correspond to the embodiment depicted in FIGS. 2 and 3. As previously mentioned, the media source 10 and data converter 16 may be located either within, or remote from, the user device 12. As shown in FIG. 16, the tracking device 20 may be held in the user's hand. During operation of the system, the user's mobility is not restricted because the tracking device 20 need not be physically connected by wires to the user device 12. As such, the user is free to move the tracking device 20 around independently of the user device 12.

Referring to FIG. 17, the user's finger is released from the trigger 22-2, and the first marker 24-1 and second marker 24-2 are disposed at an initial position relative to each other. The initial position corresponds to the reference positions of the optical markers 24. The initial position also provides an approximate position of the user's hand in world space. When the optical markers 24 lie within the field-of-view of the image capturing device 18, a first set of images of the optical markers 24 is captured by the image capturing device 18. The reference positions of the optical markers 24 can be determined by the data converter 16 using the first set of images. In one embodiment, the position of the user's hand in real world space can be obtained by tracking the first marker 24-1.

Referring to FIG. 18, the user provides a physical input to the tracking device 20 by pressing his finger onto the trigger 22-2, which causes the actuation mechanism 22-4 to move the second marker 24-2 to a new position relative to the first marker 24-1. In some embodiments, the actuation mechanism 22-4 can move both the first marker 24-1 and the second marker 24-2 simultaneously relative to each other. Accordingly, in those embodiments, a larger change in spatial relation between the first marker 24-1 and the second marker 24-2 may be obtained. Any type, range, and magnitude of motion is contemplated.

A second set of images of the optical markers 24 is then captured by the image capturing device 18. The new positions of the optical markers 24 are determined by the data converter 16 using the second set of captured images. Subsequently, the change in spatial relation between the first marker 24-1 and second marker 24-2 due to the physical input from the user is calculated by the data converter 16, using the difference between the new and reference positions of the optical markers 24 and/or the difference between the two new positions of the optical markers 24. The data converter 16 then converts the change in spatial relation between the optical markers 24 into an action in a virtual world rendered on the user device 12. The action may include, for example, a trigger action, grabbing action, toggle action, etc. In some embodiments, the action in the virtual world may be generated based on the observable presence of the markers. In those embodiments, the disappearance and/or reappearance of individual markers between times t0 and t1 may result in certain actions being generated in the virtual world, whereby time t1 is a point in time occurring after time t0. For example, in one specific embodiment, there may be four markers comprising a first marker, a second marker, a third marker, and a fourth marker. A user may generate a first action in the virtual world by obscuring the first marker, a second action in the virtual world by obscuring the second marker, and so forth. The markers may be obscured from view using various methods. For example, the markers may be obscured by blocking the markers using a card made of an opaque material, or by moving the markers out of the field-of-view of the image capturing device. Since the aforementioned embodiments are based on the observable presence of the markers (i.e., present or not-present), the embodiments are therefore well-suited for binary input so as to generate, for example, a toggle action or a switching action.

It should be noted that the change in spatial relation of/between the markers includes the spatial change for each marker, as well as the spatial difference between two or more markers. Any type of change in spatial relation is contemplated. For example, in various embodiments described herein, we define the reference image or images to be a part or portion of a broader set of reference data that can be used to determine a change in spatial relation. In an example embodiment, the reference data can include: 1) data from the use of a plurality of markers with one or more of the markers being a reference image (e.g., a portion of the reference data); 2) data from the use of one marker with images of the marker sampled at multiple instances of time, one or more of the image samples being a reference image (e.g., another portion of the reference data); 3) position/orientation data of an image capturing device (e.g., another portion of the reference data), the change in spatial relation being relative to the position/orientation data of the image capturing device; and 4) position/orientation data of a tracking device (e.g., another portion of the reference data), the change in spatial relation being relative to the position/orientation data of the tracking device. It will be apparent to those of ordinary skill in the art in view of the disclosure herein that the reference data can include other data components that can be used in determining a change in spatial relation.

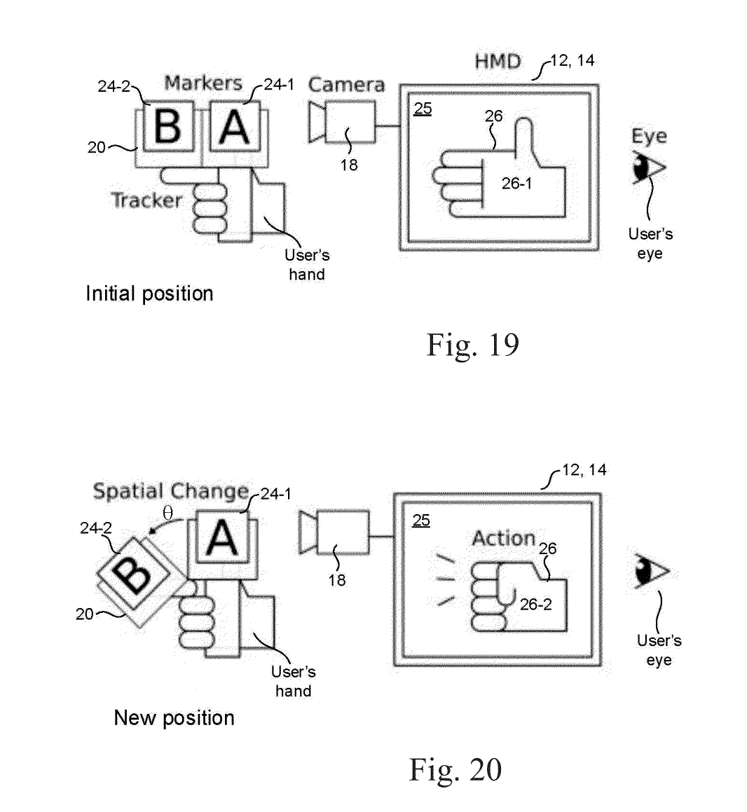

FIGS. 19 and 20 illustrate the visual output in a virtual world on the user device corresponding to the reference and new positions of the optical markers. In FIGS. 19 and 20, a virtual world 25 is displayed on the output device 14 of the user device 12. A virtual object 26 (in the shape of a virtual hand) is provided in the virtual world 25. Referring to FIG. 19, when the optical markers 24 are at their reference positions (whereby the second marker 24-2 is adjacent to the first marker 24-1 without any gap in-between the markers), the virtual object 26 is in an “open” position 26-1. Referring to FIG. 20, when the optical markers 24 are at their new positions (whereby the second marker 24-2 is rotated by an angle θ relative to the first marker 24-1), the change in spatial relation between the first marker 24-1 and the second marker 24-2 is converted by the data converter 16 into an action in the virtual world 25. To visually indicate that the action has occurred, the virtual object 26 changes from the “open” position 26-1 to a “closed” position 26-2. In the example of FIG. 20, the “closed” position 26-2 corresponds to a grab action, in which the virtual hand is in a shape of a clenched fist. In some other embodiments, the “closed” position 26-2 may correspond to a trigger action, a toggle action, or any other action or motion in the virtual world 25.

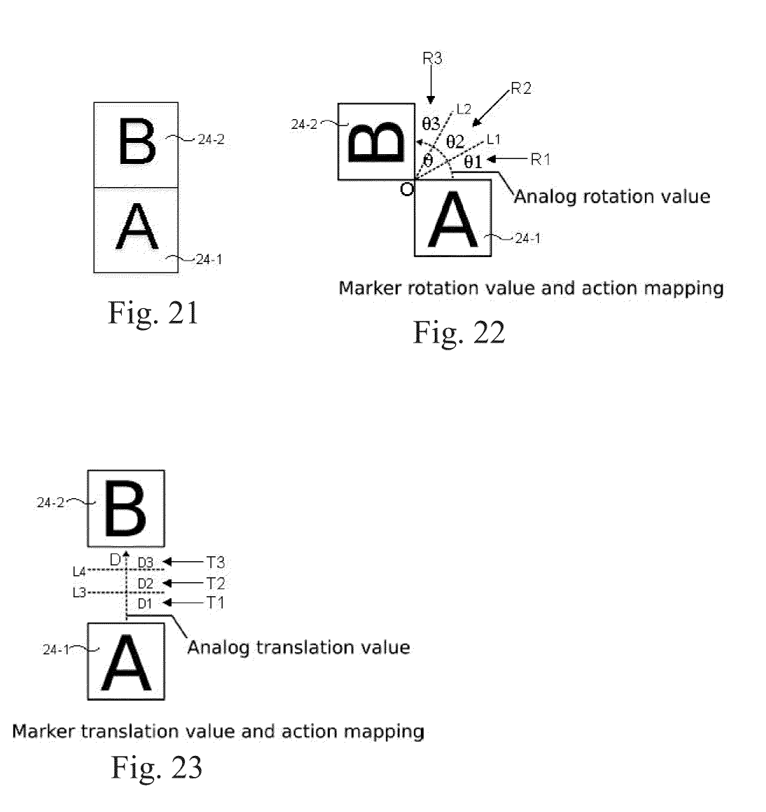

FIGS. 21, 22, 23, and 24 illustrate the spatial range of physical inputs available on an example tracking device.

Referring to FIG. 21, the optical markers 24 are in their reference positions. The reference positions may correspond to the default positions of the optical markers 24 (i.e., the positions of the optical markers 24 when no physical input is received from a user). When the optical markers 24 are in their reference positions, the trigger 22-2 and actuation mechanism 22-4 are not activated. As previously described with reference to FIG. 19, the object 26 in the virtual world 25 may be in the “open” position 26-1 when the optical markers 24 are in their reference positions (i.e., no action is performed by or on the object 26). As shown in FIG. 21, the second marker 24-2 is adjacent to the first marker 24-1 without any gap in-between when the optical markers 24 are in their reference positions.

Referring to FIG. 22, a user may apply one type of physical input to the tracking device 20. Specifically, the user can press his finger onto the trigger 22-2, which causes the actuation mechanism 22-4 to rotate the second marker 24-2 about a point O relative to the first marker 24-1 (see, for example, FIGS. 18 and 20). The angle of rotation between the first marker 24-1 and the second marker 24-2 is given by θ. In some embodiments, the user can vary the angular rotation by either applying different pressures to the trigger 22-2, holding the trigger 22-2 at a constant pressure for different lengths of time, or a combination of the above. For example, the user may increase the angular rotation by applying a greater pressure to the trigger 22-2, or decrease the angular rotation by reducing the pressure applied to the trigger 22-2. Likewise, the user may increase the angular rotation by holding the trigger 22-2 for a longer period of time at a constant pressure, or reduce the angular rotation by decreasing the pressure applied to the trigger 22-2. To improve user experience, tactile feedback from the tracking device 20 to the user can be modified, for example, by adjusting a physical resistance (such as spring tension) in the actuation mechanism 22-4/trigger 22-2.

The angular rotation of the optical markers 24 corresponds to one type of analog physical input from the user. Depending on the angle of rotation, different actions can be specified in the virtual world 25. For example, referring to FIG. 22, when the user applies a first physical input such that the angle of rotation θ falls within a first predetermined angular threshold range θ1, the data converter 16 converts the first physical input into a first action R1 in the virtual world 25. Similarly, when the user applies a second physical input such that the angle of rotation θ falls within a second predetermined angular threshold range θ2, the data converter 16 converts the second physical input into a second action R2 in the virtual world 25. Likewise, when the user applies a third physical input such that the angle of rotation θ falls within a third predetermined angular threshold range θ3, the data converter 16 converts the third physical input into a third action R3 in the virtual world 25. The first predetermined angular threshold range θ1 is defined by the angle between an edge of the first marker 24-1 and an imaginary line L1 extending outwardly from point O. The second predetermined angular threshold range θ2 is defined by the angle between the imaginary line L1 and another imaginary line L2 extending outwardly from point O. The third predetermined angular threshold range θ3 is defined by the angle between the imaginary line L2 and an edge of the second marker 24-2. Any magnitude of each range is contemplated.

It is noted that the number of predetermined angular threshold ranges need not be limited to three. In some embodiments, the number of predetermined angular threshold ranges can be more than three (or less than three), depending on the sensitivity and resolution of the image capturing device 18 and other requirements (for example, gaming functions, etc.).

It is further noted that the physical input to the tracking device 20 need not be limited to an angular rotation of the optical markers 24. In some embodiments, the physical input to the tracking device 20 may correspond to a translation motion of the optical markers 24. For example, referring to FIG. 23, a user can press his finger onto the trigger 22-2, which causes the actuation mechanism 22-4 to translate the second marker 24-2 by a distance from the first marker 24-1. The actuation mechanism 22-4 in FIG. 23 is different from that in FIG. 22. Specifically, the actuation mechanism 22-4 in FIG. 22 rotates the optical markers 24, whereas the actuation mechanism 22-4 in FIG. 23 translates the optical markers 24. Referring to FIG. 23, the translation distance between the nearest adjacent edges of the first marker 24-1 and the second marker 24-2 is given by D. In some embodiments, the user can vary the translation distance by either applying different pressures to the trigger 22-2, holding the trigger 22-2 at a constant pressure for different lengths of time, or a combination of the above. For example, the user may increase the translation distance by applying a greater pressure to the trigger 22-2, or decrease the translation distance by reducing the pressure applied to the trigger 22-2. Likewise, the user may increase the translation distance by holding the trigger 22-2 for a longer period of time at a constant pressure, or reduce the translation distance by decreasing the pressure applied to the trigger 22-2. As previously mentioned, tactile feedback from the tracking device 20 to the user can be modified to improve user experience, for example, by adjusting a physical resistance (such as spring tension) in the actuation mechanism 22-4/trigger 22-2.

The translation of the optical markers 24 corresponds to another type of analog physical input from the user. Depending on the translation distance, different actions can be specified in the virtual world 25. For example, referring to FIG. 23, when the user applies a fourth physical input such that the translation distance D falls within a first predetermined distance range D1, the data converter 16 converts the fourth physical input into a fourth action T1 in the virtual world 25. Similarly, when the user applies a fifth physical input such that the translation distance D falls within a second predetermined distance range D2, the data converter 16 converts the fifth physical input into a fifth action T2 in the virtual world 25. Likewise, when the user applies a sixth physical input such that the translation distance D falls within a third predetermined distance range D3, the data converter 16 converts the sixth physical input into a sixth action T3 in the virtual world 25. The first predetermined distance range D1 is defined by a shortest distance between an edge of the first marker 24-1 and an imaginary line L3 extending parallel to the edge of the first marker 24-1. The second predetermined distance range D2 is defined by a shortest distance between the imaginary line L3 and another imaginary line L4 extending parallel to the imaginary line L3. The third predetermined distance range D3 is defined by a shortest distance between the imaginary line L4 and an edge of the second marker 24-2 parallel to the imaginary line L4. Any magnitude of each distance range is contemplated.

It is noted that the number of predetermined distance ranges need not be limited to three. In some embodiments, the number of predetermined distance ranges can be more than three (or less than three), depending on the sensitivity and resolution of the image capturing device 18 and other requirements (for example, gaming functions, etc.).

The actions in the virtual world 25 may include discrete actions such as trigger, grab, toggle, etc. However, since the change in spatial relation (rotation/translation) between the optical markers 24 is continuous, the change may be mapped to an analog action in the virtual world 25, for example, in the form of a gradual grabbing action or a continuous pedaling action. The example embodiments are not limited to actions performed by or on the virtual object 26. For example, in other embodiments, an event (that is not associated with the virtual object 26) may be triggered in the virtual world 25 when the change in spatial relation exceeds a predetermined threshold value or falls within a predetermined threshold range.

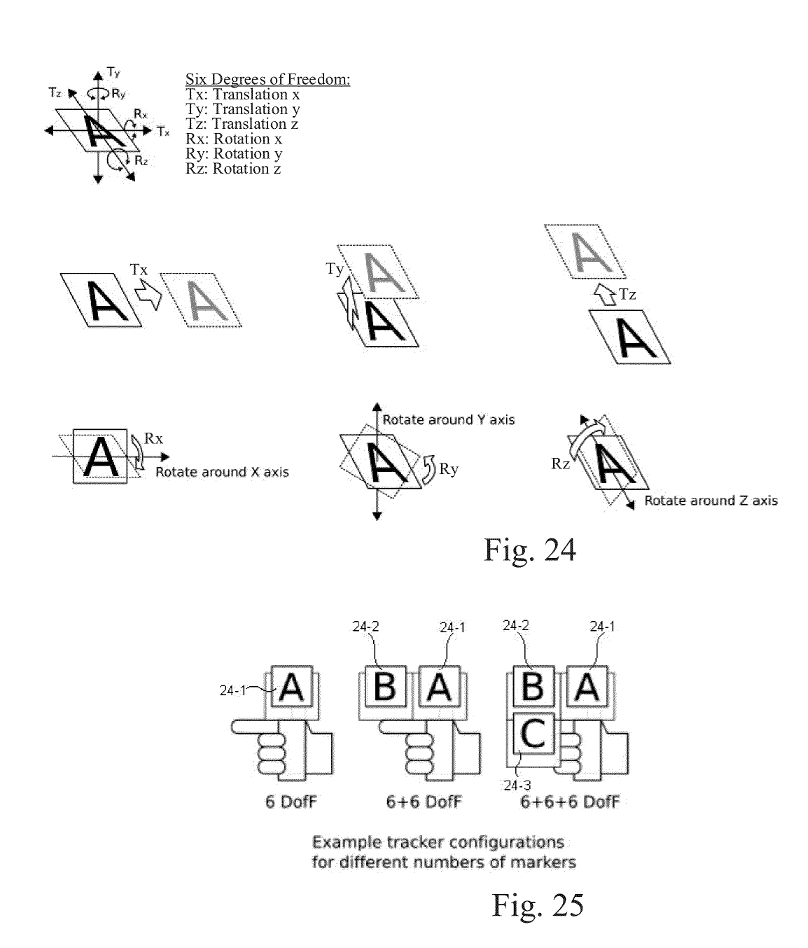

Although FIGS. 22 and 23 respectively illustrate rotation and translation of the optical markers 24 in two dimensions, it is noted that the movement of each of the optical markers 24 can be extrapolated to three dimensions having six degrees of freedom. The optical markers 24 can be configured to rotate or translate in any one or more of the three axes X, Y, and Z in a Cartesian coordinate system. For example, as shown in FIG. 24, the first marker 24-1 having the pattern “A” can translate in the X-axis (Tx), Y-axis (Ty), or Z-axis (Tz). Likewise, the first marker 24-1 can also rotate about any one or more of the X-axis (Rx), Y-axis (Ry), or Z-axis (Rz). FIG. 25 illustrates examples of tracker configurations for different numbers of optical markers 24. Any number and configuration of the optical markers 24 is contemplated. For example, in one embodiment, the tracking device 20 may consist of a first optical marker 24-1 having a pattern “A”, whereby the optical marker 24-1 is free to move in six degrees of freedom. In another embodiment, the tracking device 20 may consist of a first optical marker 24-1 having a pattern “A” and a second optical marker 24-2 having a pattern “B”, whereby each of the optical markers 24-1 and 24-2 is free to move in six degrees of freedom. In a further embodiment, the tracking device 20 may consist of a first optical marker 24-1 having a pattern “A”, a second optical marker 24-2 having a pattern “B”, and a third optical marker 24-3 having a pattern “C”, whereby each of the optical markers 24-1, 24-2, and 24-3 is free to move in six degrees of freedom.

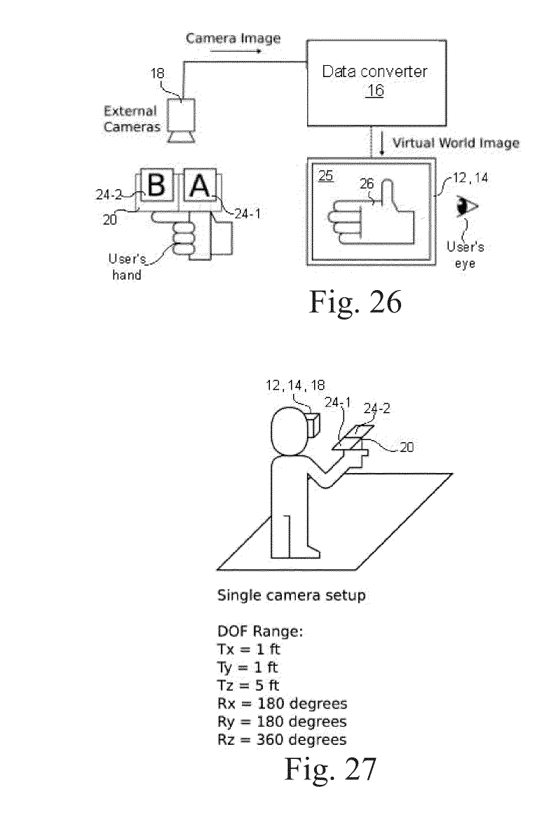

FIG. 26 illustrates an example system in which a single image capturing device 18 is used to detect changes in the spatial relation between the optical markers 24. As shown in FIG. 26, the data converter 16 is connected between the image capturing device 16 and the user device 12. The data converter 16 may be configured to control the image capturing device 18, receive imaging data from the image capturing device 18, process the imaging data to determine reference positions of the optical markers 24, measure a change in spatial relation between the optical markers 24 when a user provides a physical input to the tracking device 20, determine whether the change in spatial relation falls within a predetermined threshold range, and generate an action in the virtual world 25 on the user device 12, if the change in spatial relation falls within the predetermined threshold range.

As mentioned above, the system in FIG. 26 has a single image capturing device 18. The detectable distance/angular range for each degree-of-freedom in the system of FIG. 26 is illustrated in FIG. 27, and is limited by the field-of-view of the image capturing device 18. For example, in one embodiment, the detectable translation distance between the optical markers 24 may be up to 1 ft. in the X-direction, 1 ft. in the Y-direction, and 5 ft. in the Z-direction; and the detectable angular rotation of the optical markers 24 may be up to 180° about the X-axis, 180° about the Y-axis, and 360° about the Z-axis.

In some embodiments, the system may include a fail-safe mechanism that allows the system to use the last known position of the tracking device 20 if the tracking device moves out of the detectable distance/angular range in a degree-of-freedom. For example, if the image capturing device 18 loses track of the optical markers 24, or if the tracking data indicates excessive movement (which may be indicative of a tracking error), the system uses the last known tracking value instead.

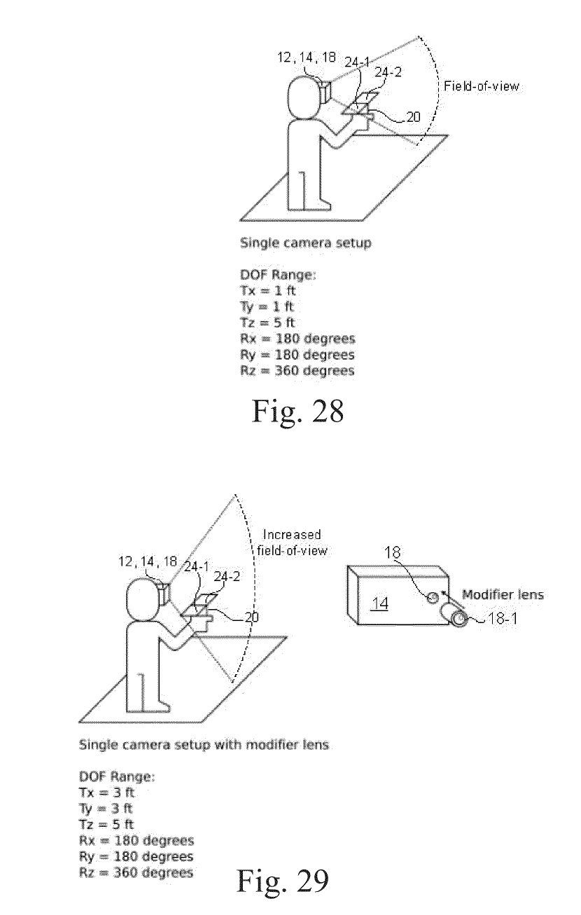

FIG. 28 illustrates the field-of-view of the image capturing device 18 of FIG. 27. In some embodiments, a modifier lens 18-1 may be attached to the image capturing device 18 to increase its field-of-view, as illustrated in FIG. 29. For example, comparing the embodiments in FIGS. 28 and 29, the detectable translation distance between the optical markers 24 may be increased from 1 ft. to 3 ft. in the X-direction, and 1 ft. to 3 ft. in the Y-direction, after the modifier lens 18-1 has been attached to the image capturing device 18.

In some embodiments, to further increase the detectable distance/angular range for each degree-of-freedom, multiple image capturing devices 18 can be placed at different locations and orientations to capture a wider range of the degrees of freedom of the optical markers 24.

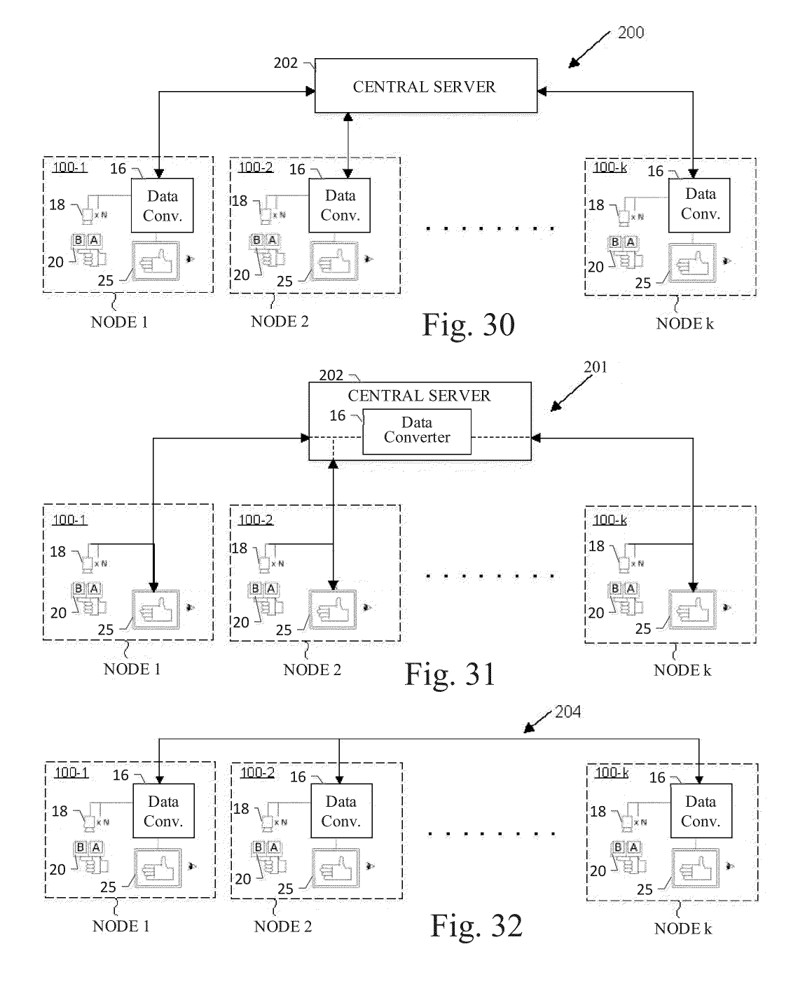

In some embodiments, a plurality of users may be immersed in a multi-user virtual world 25, for example, in a massively multiplayer online role-playing game. FIG. 30 illustrates a multi-user system 200 that allows users to interact with one another in the virtual world 25. Referring to FIG. 30, the multi-user system 200 includes a central server 202 and a plurality of systems 100.

The central server 202 can include a web server, an enterprise server, or any other type of computer server, and can be computer programmed to accept requests (e.g., HTTP, or other protocols that can initiate data transmission) from each system 100 and to serve each system 100 with requested data. In addition, the central server 202 can be a broadcasting facility, such as free-to-air, cable, satellite, and other broadcasting facility, for distributing data.

Each system 100 in FIG. 30 may correspond to the system 100 depicted in FIG. 1. Each system 100 may have a participant. A “participant” may be a human being. In some particular embodiments, the “participant” may be a non-living entity such as a robot, etc. The participants are immersed in the same virtual world 25, and can interact with one another in the virtual world 25 using virtual objects and/or actions. The systems 100 may be co-located, for example in a room or a theater. When the systems 100 are co-located, multiple image capturing devices (e.g., N number of image capturing devices, whereby N is greater than or equal to 2) may be installed in that location to improve optical coverage of the participants and to eliminate blind spots. However, it is noted that the systems 100 need not be in the same location. For example, in some other embodiments, the systems 100 may be at remote geographical locations (e.g., in different cities around the world).

The multi-user system 200 may include a plurality of nodes. Specifically, each system 100 corresponds to a “node.” A “node” is a logically independent entity in the system 200. If a “system 100” is followed by a number or a letter, it means that the “system 100” corresponds to a node sharing the same number or letter. For example, as shown in FIG. 30, system 100-1 corresponds to node 1 which is associated with participant 1, and system 100-k corresponds to node k which is associated with participant k. Each participant may have unique patterns on their optical markers 24 so as to distinguish their identities.

Referring to FIG. 30, the bi-directional arrows between the central server 202 and the data converter 16 in each system 100 indicate two-way data transfer capability between the central server 202 and each system 100. The systems 100 can communicate with one another via the central server 202. For example, imaging data, as well as processed data and instructions pertaining to the virtual world 25, may be transmitted to/from the systems 100 and the central server 202, and among the systems 100.

The central server 202 collects data from each system 100, and generates an appropriate custom view of the virtual world 25 to present at the output device 14 of each system 100. It is noted that the views of the virtual world 25 may be customized independently for each participant.

FIG. 31 is a multi-user system 202 according to another embodiment, and illustrates that the data converters 16 need not reside within the systems 100 at each node. As shown in FIG. 31, the data converter 16 can be integrated into the central server 202, and therefore remote to the systems 100. In the embodiment of FIG. 31, the image capturing device 18 or user device 12 in each system 100 transmits imaging data to the data converter 16 in the central server 202 for processing. Specifically, the data converter 16 can detect the change in spatial relation between the optical markers 24 at each tracking device 20 whenever a participant provides a physical input to their tracking device 20, and can generate an action in the virtual world 25 corresponding to the change in spatial relation. This action may be observed by the participant providing the physical input, as well as other participants in the virtual world 25.

FIG. 32 is a multi-user system 204 according to a further embodiment, and is similar to the multi-user systems 200 and 202 depicted in FIGS. 30 and 31, except for the following difference. In the embodiment of FIG. 32, the systems 100 need not be connected to one another through a central server 202. As shown in FIG. 32, the systems 100 can be directly connected to one another through a network. The network may be a Local Area Network (LAN) and may be wireless, wired, or a combination thereof.

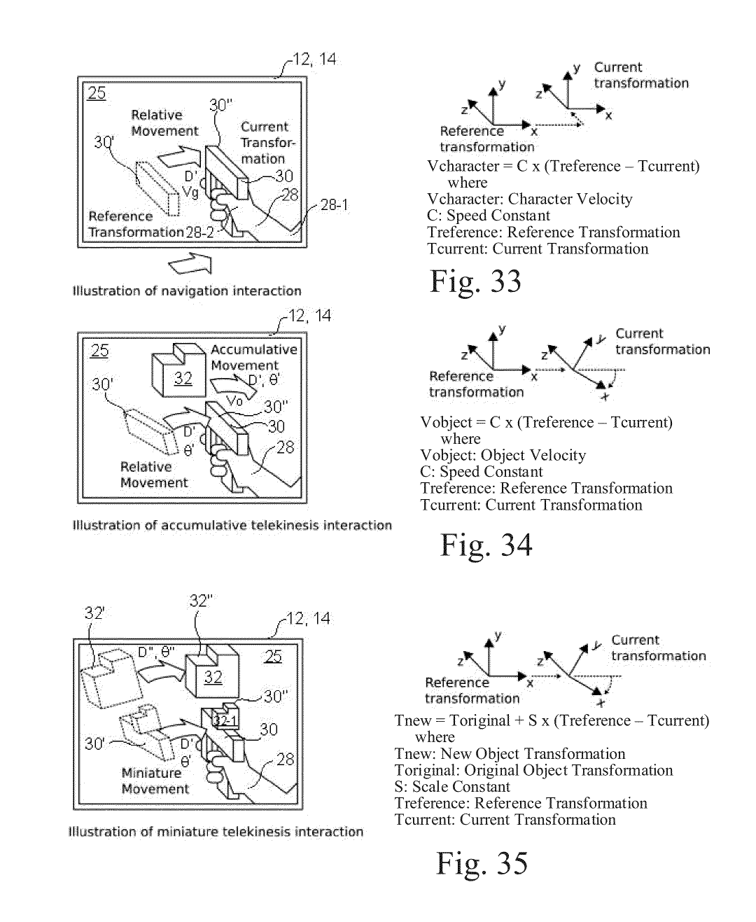

FIGS. 33, 34, and 35 illustrate example actions generated in a virtual world according to different embodiments. In each of FIGS. 33, 34, and 35, a virtual world 25 is displayed on an output device 14 of a user device 12. User interface (UI) elements may be provided in the virtual world 25 to enhance user experience with the example system. The UI elements may include a virtual arm, virtual hand, virtual equipment (such as a virtual gun or laser pointer), virtual objects, etc. A user can navigate through, and perform different actions in, the virtual world 25 using the UI elements.

FIG. 33 is an example of navigation interaction in the virtual world 25. Specifically, a user can navigate through the virtual world 25 by moving the tracking device 20 in the real world. In FIG. 33, a virtual arm 28 with a hand holding a virtual gun 30 is provided in the virtual world 25. The virtual arm 28 and virtual gun 30 create a strong visual cue helping the user to immerse into the virtual world 25. As shown in FIG. 33, an upper portion 28-1 of the virtual arm 28 (above the elbow) is bound to a hypothetical shoulder position in the virtual world 25, and a lower portion 28-2 of the virtual arm 28 (the virtual hand) is bound to the virtual gun 30. The elbow location and orientation of the virtual arm 28 can be interpolated using inverse kinetics which is known to those of ordinary skill in the art.

The scale of the virtual world 25 may be adjusted such that the location of the virtual equipment (virtual arm 28 and gun 30) in the virtual world 25 appears to correspond to the location of the user's hand in the real world. The virtual equipment can also be customized to reflect user operation. For example, when the user presses the trigger 22-2 on the rig 22, a trigger on the virtual gun 30 will move accordingly.

In the example of FIG. 33, the user can use the tracking device 20 as a joystick to navigate in the virtual world 25. As previously mentioned, the image capturing device 18 has a limited field-of-view, which limits the detectable range of motions on the tracking device 20. In some embodiments, an accumulative control scheme can be used in the system, so that the user can use a small movement of the tracking device 20 to control a larger movement in the virtual world 25. The accumulative control scheme may be provided as follows.

First, the user presses the trigger 22-2 on the tracking device 20 to record a reference transformation. Next, the user moves the tracking device 20 a distance D away from its reference/original position. Next, the data converter 16 calculates the difference in position and rotation between the current transformation and reference transformation. Next, the difference in position and rotation is used to calculate the velocity and angular velocity at which the virtual objects move around the virtual world 25. It is noted that if the user keeps the same relative difference to the reference transformation, the virtual object will move constantly toward that direction. For example, a velocity Vg of the virtual gun 30 may be calculated using the following equation:

Vg=C×(Tref−Tcurrent)

where C is a speed constant, Tref is the reference transformation, and Tcurrent is the current transformation.

Referring to FIG. 33, when the user moves the tracking device 20 by the distance D and velocity V in the real world, the virtual arm 28 moves the virtual gun 30 from a first position 30′ to a second position 30″ by a distance D′ and velocity V in the virtual world 25. The distance D′ and velocity V in the virtual world 25 may be scaled proportionally to the distance D and velocity V in the real world. Accordingly, the user can intuitively sense how much the virtual gun 30 has moved, and how fast the virtual gun 30 is moving in the virtual world 25.

In the example of FIG. 33, the virtual gun 30 is moved from left to right in the X-axis of the virtual world 25. Nevertheless, it should be understood that the user can move the virtual arm 28 and gun 30 anywhere along or about the X, Y, and Z axes of the virtual world 25, either via translation and/or rotation.

In some embodiments, the user may navigate and explore the virtual world 25 by foot or in a virtual vehicle. This includes navigating on ground, water, or air in the virtual world 25. When navigating by foot, the user can move the tracking device 20 front/back to move corresponding virtual elements forward/backward or move the tracking device 20 left/right to strafe (move virtual elements sideways). The user can also turn user device 12 to turn the virtual elements or change the view in the virtual world 25. When controlling a virtual vehicle, the user can use the tracking device 20 to go forward/backward, or turn/tilt left or right. For example, when flying the virtual vehicle, the user can move the tracking device 20 up/down and the trigger 22-2 to control the throttle. Turning the user device 12 should have no effect on the direction of the virtual vehicle, since the user should be able to look around in the virtual world 25 without the virtual vehicle changing direction (as in the real world).

As previously described, actions can be generated in the virtual world 25, if the change in spatial relation between the optical markers 24 falls within a predetermined threshold range. FIGS. 34 and 35 illustrate different types of actions that can be generated in the virtual world 25. Specifically, FIGS. 34 and 35 involve using a telekinesis scheme to move objects in the virtual world 25 whereby the movement range is greater than the sensing area of the tracking device 20. Using the telekinesis scheme, a user can grab, lift or turn remote virtual objects in the virtual world 25. Telekinesis provides a means of interacting with virtual objects in the virtual world 25, especially when physical feedback (e.g., object hardness, weight, etc.) is not applicable. Telekinesis may be used in conjunction with the accumulative control scheme (described previously in FIG. 33) or with a miniature control scheme.

FIG. 34 is an example of accumulative telekinesis interaction in the virtual world 25. Specifically, FIG. 34 illustrates an action whereby a user can move another virtual object 32 using the virtual arm 28 and the virtual gun 30. In FIG. 34, the virtual object 32 is located at a distance from the virtual gun 30, and synchronized with the virtual gun 30 such that the virtual object 32 moves in proportion with the virtual gun 30. To move the virtual object 32, the user may provide a physical input to the tracking device 20 causing a change in spatial relation of/between the optical markers 24. The change in spatial relation may be, for example, a translation of the tracking device 20 by a distance D in the X-axis in the real world. If the change in spatial relation (i.e., distance D) falls within a predetermined distance range, the data converter 16 then generates an action in the virtual world 25. Specifically, the action involves moving the virtual gun 30 from a first position 30′ to a second position 30″ by a distance D′ in the X-axis and an angle θ′ about the Z-axis of the virtual world 25. The distance D′ and angle θ′ in the virtual world 25 may be proportional to the distance D and angle θ in the real world. Accordingly, the user can intuitively sense how much the virtual gun 30 has moved, how fast the virtual gun 30 is moving, and the actual path traversed by the virtual gun 30 in the virtual world 25. As mentioned above, since the virtual object 32 is synchronized with the virtual gun 30 and moves with the virtual gun 30, the virtual object 32 also moves by a distance D′ in the X-axis and an angle θ′ about the Z-axis of the virtual world 25. Accordingly, the user can use the virtual gun 30 to control objects at a distance in the virtual world 25. The velocity Vo of the virtual object 32 may be calculated using the following equation:

Vo=C×(Tref−Tcurrent)

where C is a speed constant, Tref is the reference transformation, and Tcurrent is the current transformation.

FIG. 35 is an example of miniature telekinesis interaction in the virtual world 25. FIG. 35 also illustrates an action whereby a user can move another virtual object 32 using the virtual arm 28 and the virtual gun 30. However, unlike the example of FIG. 34, the virtual object 32 in FIG. 35 is synchronized with the virtual gun 30 such that the virtual object 32 moves in greater proportion relative to the virtual gun 30. To move the virtual object 32 in FIG. 35, the user may provide a physical input to the tracking device 20 causing a change in spatial relation between the optical markers 24. The change in spatial relation may be, for example, a translation of the tracking device 20 by a distance D in the X-axis in the real world. If the change in spatial relation (i.e., distance D) falls within a predetermined distance range, the data converter 16 then generates an action in the virtual world 25. Specifically, the action involves moving the virtual gun 30 from a first position 30′ to a second position 30″ by a distance D′ in the X-axis and an angle θ′ about the Z-axis of the virtual world 25. The distance D′ and angle θ′ in the virtual world 25 may be proportional to the distance D and angle θ in the real world. Accordingly, the user can intuitively sense how much the virtual gun 30 has moved, how fast the virtual gun 30 is moving, and the actual path traversed by the virtual gun 30 in the virtual world 25. As mentioned above, the virtual object 32 in FIG. 35 is synchronized with the virtual gun 30 and moves in greater proportion relative to the virtual gun 30. Thus, the action also involves moving the virtual object 32 from a first position 32′ to a second position 32″ by a distance D″ in the X-axis and an angle θ″ about the Z-axis of the virtual world 25, whereby D″>D′ and θ″=θ′. Accordingly, the user can use the virtual gun 30 to control virtual objects at a distance in the virtual world 25, and manipulate the virtual objects to have a wider range of motion in the virtual world 25.

As shown in FIG. 35, a miniature version 32-1 of the virtual object 32 is disposed on the virtual gun 30. The miniature telekinesis control scheme may be provided as follows. First, the user presses the trigger 22-2 on the tracking device 20 to record a reference transformation. Next, the user moves the tracking device 20 a certain distance away from the reference transformation to a new transformation. Next, the transformation matrix between the current transformation and the reference transformation is calculated. Next, the transformation matrix is multiplied by a scale factor, which reflects the scale difference between the object 32 and the miniature version 32-1. The new transformation Tnew of the virtual object 32 in FIG. 35 may be calculated using the following equation:

Tnew=Torig+S×(Tref−Tcurrent)

where Torig is the original transformation of the virtual object 32, S is a scale constant between the object 32 and the miniature version 32-1, Tref is the reference transformation, and Tcurrent is the current transformation.

Additional UI (user interface) guides can be added to help the user understand the status of the tracking or action. For example, linear arrows can be used to represent how far/fast the virtual elements are moving in a straight line, and curvilinear arrows can be used to represent how far/fast the virtual elements are rotating. The arrows may be a combination of linear arrows and curvilinear arrows, for example, as shown in FIGS. 33, 34, and 35. In some embodiments, status bars or circles may be used to represent the analog value of the user input (for example, how fast the user is pedaling).

In the examples of FIGS. 34 and 35, the virtual object 32 is controlled using the telekinesis scheme, which offers the following benefits over shadowing. In shadowing, a virtual character follows exactly a human's movements. First, shadowing does not work if the virtual character has a different proportion or scale from the controller. Unlike shadowing, the example system works well with different proportions and scales. In particular, proportion is not a critical factor in the example system, because the virtual arm 28 is controlled using relative motion.

Second, the user usually has to wear heavy sensors with cords during shadowing. The example system, in contrast, is lightweight and cordless.

Third, in shadowing, the movement of a virtual arm may be impeded when the controller's arm is blocked by physical obstacles or when carrying heavy weight. In contrast, the telekinesis control scheme in the example system is more intuitive, because it is not subject to physical impediments and the control is relative.

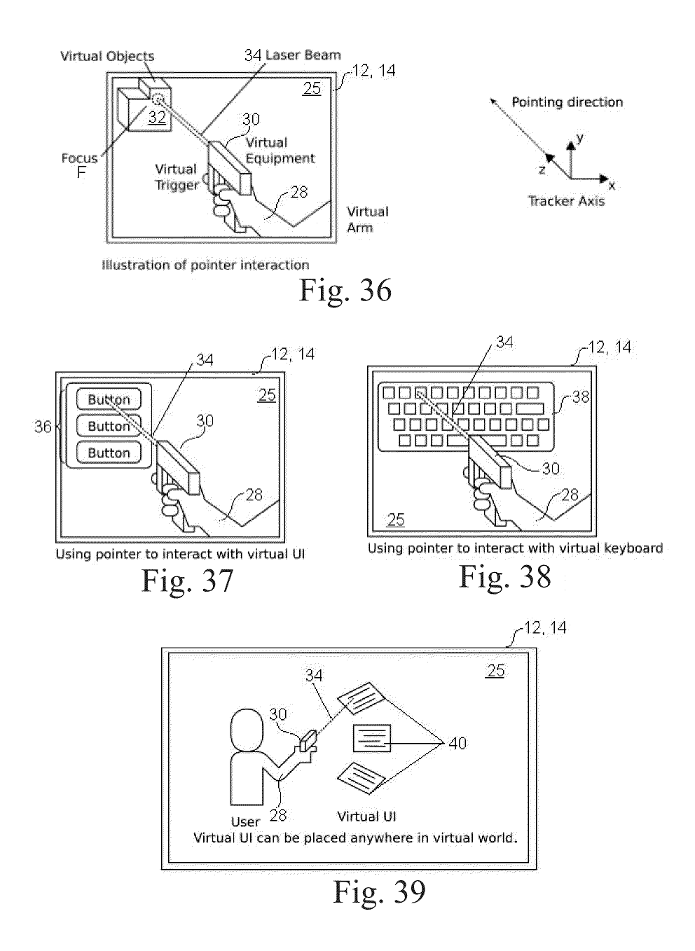

FIGS. 36, 37, 38, and 39 illustrate further example actions generated in a virtual world according to different embodiments. The embodiments in FIGS. 36, 37, 38, and 39 are similar to those described in FIGS. 33, 34, and 35, but have at least the following difference. In the embodiments of FIGS. 36, 37, 38, and 39, the virtual gun 30 includes a pointer generating a laser beam 34, and the virtual world 25 includes other types of user interfaces and virtual elements. The laser beam 34 represents the direction in which the virtual gun 30 is pointed and provides a visual cue for the user (thereby serving as pointing device). In addition, the laser beam 34 can be used to focus on different virtual objects, and to perform various actions (e.g., shoot, push, select, etc.) on the different virtual objects in the virtual world 25.

Referring to FIG. 36, a user can focus the laser beam 34 on the virtual object 32 by moving the virtual gun 30 using the method described in FIG. 33. Once the laser beam 34 is focused on the virtual object 32, different actions (e.g., shooting, toppling, moving, etc.) can be performed. For example, the user may provide a physical input to the tracking device 20 causing a change in spatial relation between the optical markers 24. If the change in spatial relation falls within a predetermined threshold range, the data converter 16 generates an action in the virtual world 25, whereby the virtual gun 30 fires a shot at the virtual object 32 causing the virtual object 32 to topple over or disappear. In some embodiments, after the laser beam 34 is focused on the virtual object 32, the user may be able to move the virtual object 32 around using one or more of the methods described in FIG. 34 or 35. For example, to ‘lock’ onto the virtual object 32, the user may press and hold the trigger 22-2 on the tracking device 20. To drag or move the virtual object 32 around, the user may press the trigger 22-2 and move the tracking device 20 using the laser beam 34 as a guiding tool.

In some embodiments, the user can use the virtual gun 30 to interact with different virtual user interfaces (UIs) in the virtual world 25. The mode of interaction with the virtual UIs may be similar to real world interaction with conventional UIs (e.g., buttons, dials, checkboxes, keyboards, etc.). For example, referring to FIG. 37, a virtual user interface may include a tile of virtual buttons 36, and the user can select a specific button 36 by focusing the laser beam 34 on that virtual button. As shown in FIG. 38, another type of virtual user interface may be a virtual keyboard 38, and the user can select a specific key on the virtual keyboard 38 by focusing the laser beam 34 on that virtual key. For example, to select (‘tap’) a virtual button or key, the user may press the trigger 22-2 on the tracking device 20 once.

In some embodiments, a plurality of virtual user interfaces 40 may be provided in the virtual world 25, as shown in FIG. 39. In those embodiments, the user can use the pointer/laser beam 34 to interact with each of the different virtual user interfaces 40 simultaneously. Since the example system allows a wide range of motion in six degrees-of-freedom in the virtual space, the virtual user interfaces 40 can therefore be placed in any location within the virtual world 25.

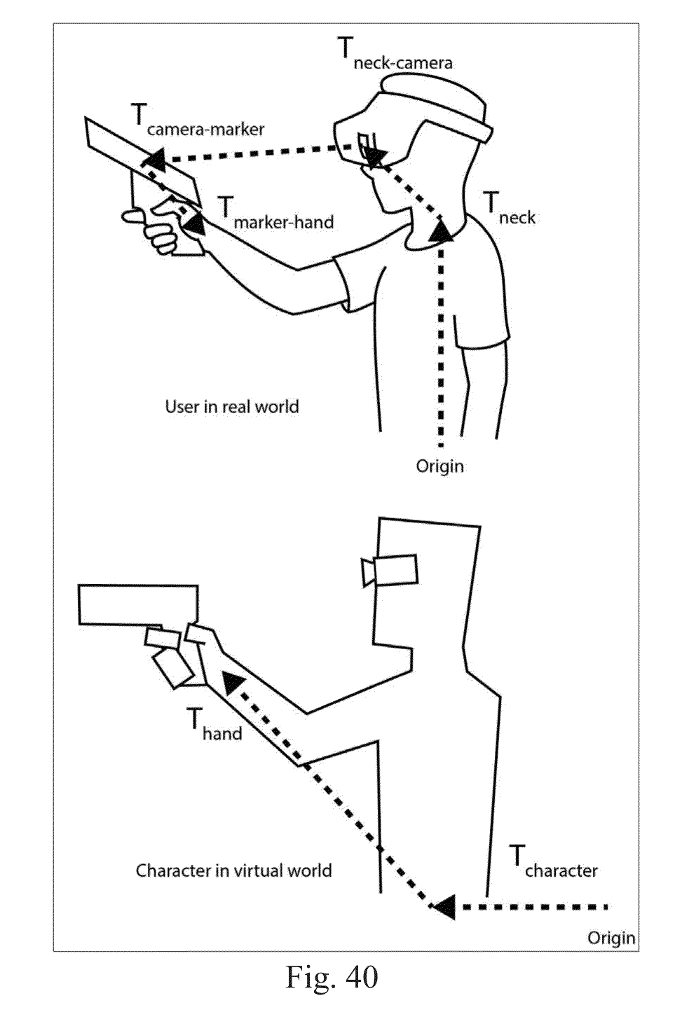

In an example embodiment, a virtual pointer can be implemented using one unique marker and the image recognition techniques described above. In the simplest embodiment, we use one marker to track the user's hand in the virtual world. An example embodiment is shown in FIG. 40. This embodiment can be implemented as follows:
We can use the VR headset to provide us with the transformation of the character's head in virtual reality. Because our physical head is rotating about the neck joint, we can store values representing this motion in: Tneck. If the device doesn't provide absolute position tracking and only has orientation tracking (e.g., only uses a gyroscope), we can use an average adult height as the position (e.g. (0, AverageAdultHeight, 0));
The camera lens has a relative transformation against T_{neck}; we can store values representing this transformation in T neck-camera;
The image recognition software can analyze the image provided by the camera and obtain the transformation of marker A against the camera lens; we can store values representing this transformation in T_{camera-marker};
In the real world, the marker A has a transformation against the user's wrist or hand; we can store values representing this transformation in T_{marker-hand};
The transformation of the virtual character can be stored in T_{character}; and
The absolute transformation of the user's hand, T_{hand} can be computed as follows:

T_{hand}=T_{character}+T_{neck}+T_{neck-camera}+T_{camera-marker}+T_{marker-hand}

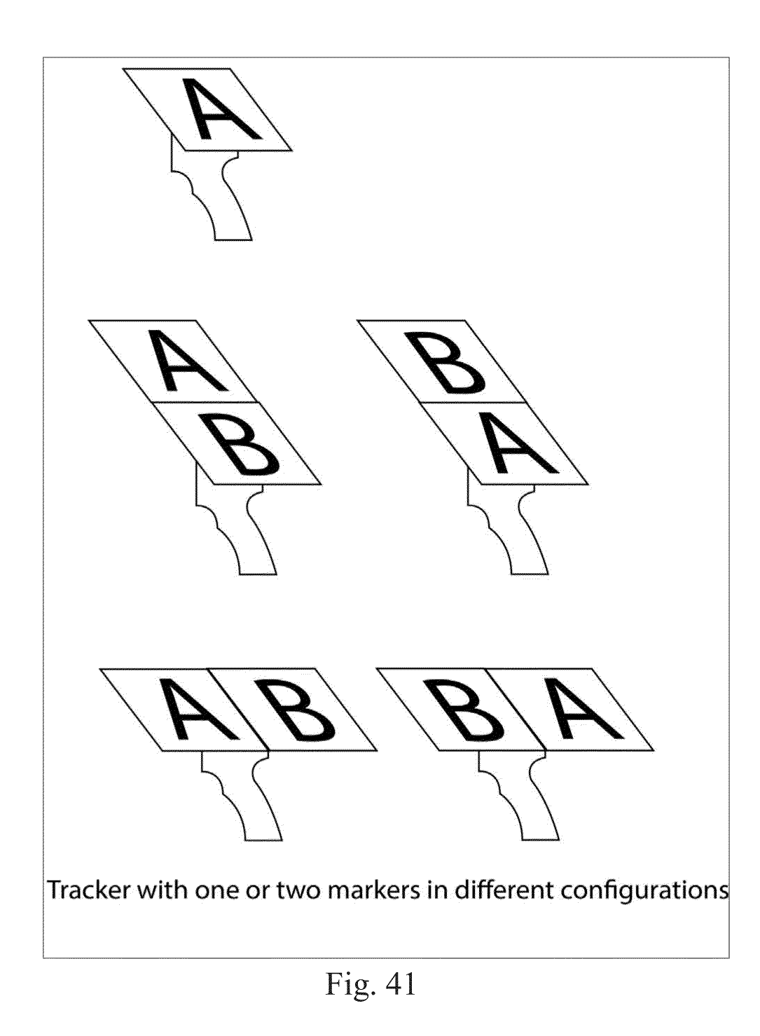

In the example embodiment, we can add another marker and use the spatial difference to perform different actions. Also, we can include more markers into the system for more actions. Various example embodiments are shown in FIG. 41. Additionally, markers are not limited to 2D planar markers; we can use 3D objects as our marker.

In another example embodiment, character navigation can be implemented with an accelerometer or pedometer. We can use this process to take acceleration data from a user device's accelerometer and convert the acceleration data into character velocity in the virtual world. This embodiment can be implemented as follows:
We record the acceleration data;
Process the raw acceleration value with a noise reduction function; and
When the processed value passes certain pre-determined limits, step count plus one, and then add a certain velocity onto the virtual character so it moves in the virtual world.

This embodiment can be specifically implemented as follows:

```
// FastAccel tracks current device acceleration in faster rate
// SlowAccel tracks current device acceleration in slower rate
// DeltaTime is the time span for each frame refreshing =
1 / FramePerSecond
// Delta is the difference between FastAccel and SlowAccel
// When Delta become greater than HighLimit, we set State to true and
count one step
// When Delta become smaller than LowLimit, we set State to false
Function StepCounter
    FastAccel = Lerp (FastAccel, DeviceAccelY, DeltaTime * FastFreq)
    SlowAccel = Lerp (SlowAccel, DeviceAccelY, DeltaTime *
    SlowFreq)
    Delta - FastAccel - SlowAccel  if State is not true:
          if Delta > HighLimit
                State = true
                Step++
          else if Delta < LowLimit
              State = false
    SlowAccel = FastAccel; return
    Step
// LastStep: Step value in last frame
Function PlayerControl
    if Step > LastStep
          // By default, CharacterDirection is the direction that
          character facing
          // projected on y plane
          CharacterVelocity += CharacterDirection * StepSpan
          LastStep = Step
```

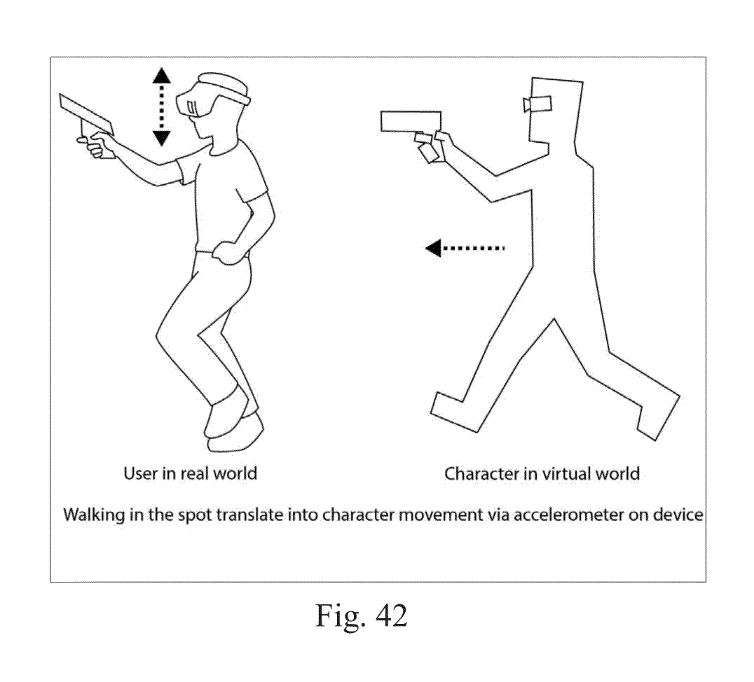

Using the example embodiment described above, the user can just walk on the spot or walk in place and their virtual character will walk in a corresponding manner in the virtual world. This example embodiment is shown in FIG. 42.

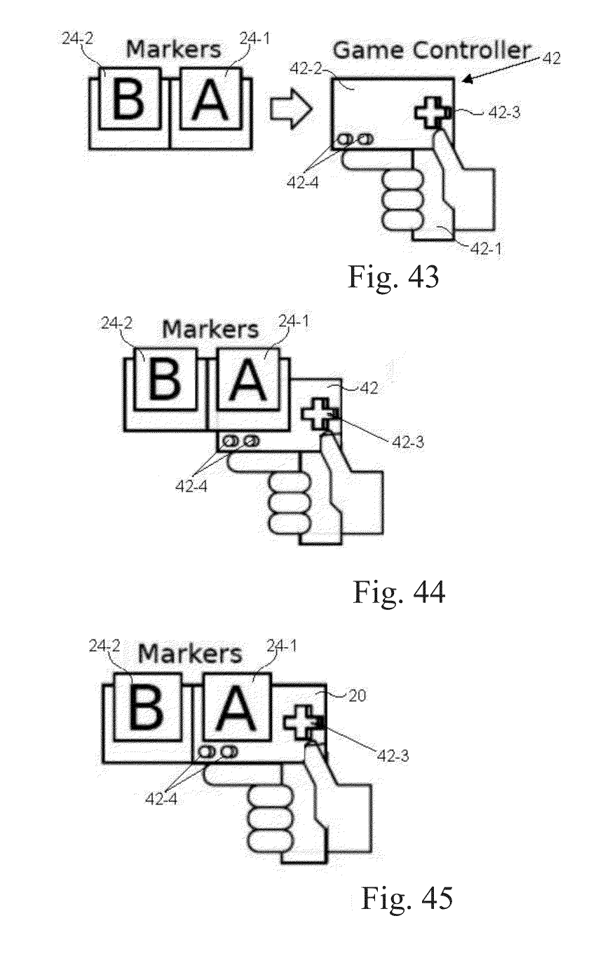

FIGS. 43 and 44 depict different embodiments in which the optical markers are adapted to a game controller. Referring to FIGS. 43 and 44, the tracking device 20 may be replaced by a game controller 42 on which optical markers 24 (e.g., first marker 24-1 and second marker 24-2) are mounted. The game controller 42 may include a handle 42-1 and a marker holder 42-2. The optical markers 24 are configured to be attached to the marker holder 42-2. The “trigger” mechanism on the tracking device 20 may be replaced by direction control buttons 42-3 and action buttons 42-4 on the game controller 42. Specifically, the direction control buttons 42-3 can be used to control the direction of navigation in the virtual world, and the action buttons 42-4 can be used to perform certain actions in the virtual world (e.g., shoot, toggle, etc.).

In some embodiments, the direction control buttons 42-3 and action buttons 42-4 may be integrated onto the tracking device 20, for example, as illustrated in FIG. 45.

In the embodiments of FIGS. 43, 44, and 45, the direction control buttons 42-3 and action buttons 42-4 may be configured to send electrical signals to, and receive electrical signals from, one or more of the components depicted in FIG. 1. As such, the game controller 42 in FIG. 44, and also the tracking device 20 in FIG. 45, may be operatively connected to one or more of the media source 10, user device 12, output device 14, data converter 16, and image capturing device 18 depicted in FIG. 1, via a network or any type of communication links that allow transmission of data from one component to another. The network may include Local Area Networks (LANs), Wide Area Networks (WANs), Bluetooth™, and/or Near Field Communication (NFC) technologies, and may be wireless, wired, or a combination thereof

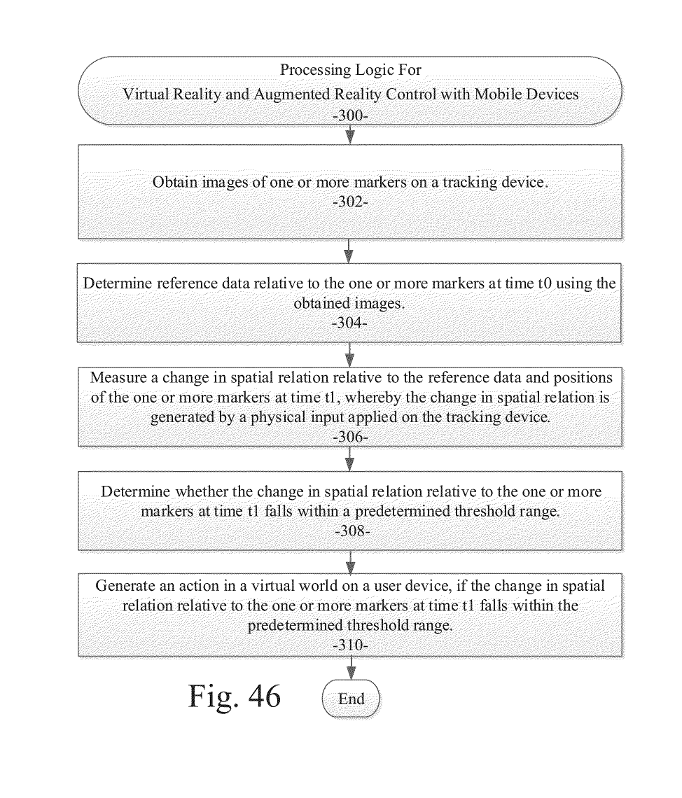

FIG. 46 is a flow chart illustrating an example method for converting a physical input from a user into an action in a virtual world. Referring to FIG. 46, method 300 includes the following steps. First, images of one or more markers on a tracking device (e.g., tracking device 20) are obtained (Step 302). The images may be captured using an image capturing device (e.g., image capturing device 18). Next, reference data relative to the one or more markers at time t0 are determined using the obtained images (Step 304). The reference data may be determined using a data converter (e.g., data converter 16). Next, a change in spatial relation relative to the reference data and positions of the one or more markers at time t1 is measured, whereby the change in spatial relation is generated by a physical input applied on the tracking device (Step 306). Time t1 is a point in time that is later than time t0. The change in spatial relation may be measured by the data converter. The user input may correspond to a physical input to the tracking device 20 causing the one or more markers to move relative to each other. The user input may also correspond to a movement of the tracking device 20 in the real world. Next, the data converter determines whether the change in spatial relation relative to the one or more markers at time t1 falls within a predetermined threshold range (Step 308). If the change in spatial relation relative to the one or more markers at time t1 falls within the predetermined threshold range, the data converter generates an action in a virtual world rendered on a user device (e.g., user device 12) (Step 310). In some embodiments, any of the one or more markers may be used to determine a position of an object in the virtual world. Specifically, the data converter can calculate the spatial difference of any of the one or more markers between times t0 and t1 to determine the position of the object in the virtual world. In some embodiments, actions in the virtual world may be generated based on the observable presence of the markers. In those embodiments, the disappearance and/or reappearance of individual markers between times t0 and t1 may result in certain actions being generated in the virtual world.

The methods disclosed herein may be implemented as a computer program product, i.e., a computer program tangibly embodied in a non-transitory information carrier, e.g., in a machine-readable storage device, or a tangible non-transitory computer-readable medium, for execution by, or to control the operation of, data processing apparatus, e.g., a programmable processor, a computer, or multiple computers. A computer program may be written in any form of programming language, including compiled or interpreted languages, and it may be deployed in any form, including as a standalone program or as a module, component, subroutine, or other unit suitable for use in a computing environment. A computer program may be deployed to be executed on one computer or on multiple computers at one site or distributed across multiple sites and interconnected by a communication network. A portion or all of the systems disclosed herein may also be implemented by an application-specific integrated circuit (ASIC), a field-programmable gate array (FPGA), a complex programmable logic device (CPLD), a printed circuit board (PCB), a digital signal processor (DSP), a combination of programmable logic components and programmable interconnects, a single central processing unit (CPU) chip, a CPU chip combined on a motherboard, a general purpose computer, or any other combination of devices or modules capable of processing optical image data and generating actions in a virtual world based on the methods disclosed herein. It is understood that the above-described example embodiments are for illustrative purposes only and are not restrictive of the claimed subject matter. Certain parts of the system can be deleted, combined, or rearranged, and additional parts can be added to the system. It will, however, be evident that various modifications and changes may be made without departing from the broader spirit and scope of the claimed subject matter as set forth in the claims that follow. The specification and drawings are accordingly to be regarded as illustrative rather than restrictive. Other embodiments of the claimed subject matter may be apparent to those of ordinary skill in the art from consideration of the specification and practice of the claimed subject matter disclosed herein.

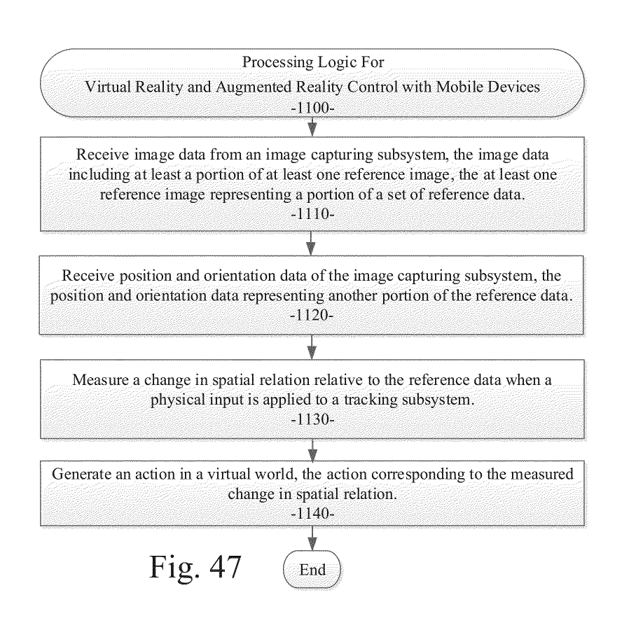

Referring now to FIG. 47, a processing flow diagram illustrates an example embodiment of a method 1100 as described herein. The method 1100 of an example embodiment includes: receiving image data from an image capturing subsystem, the image data including at least a portion of at least one reference image, the at least one reference image representing a portion of a set of reference data (processing block 1110); receiving position and orientation data of the image capturing subsystem, the position and orientation data representing another portion of the reference data (processing block 1120); measuring, by use of a data processor, a change in spatial relation relative to the reference data when a physical input is applied to a tracking subsystem (processing block 1130); and generating an action in a virtual world, the action corresponding to the measured change in spatial relation (processing block 1140).

An Example Embodiment with a SmartController

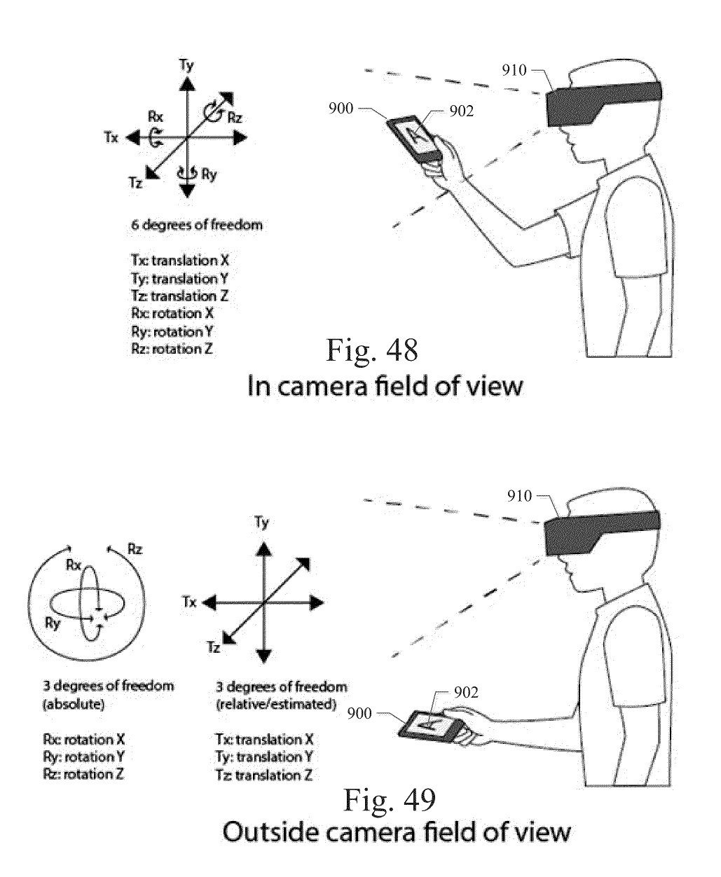

In another example embodiment, a universal motion-tracking controller (denoted herein a SmartController) can be implemented to provide a means for controlling the VR/AR experience. In an example embodiment, the SmartController can include: accelerometers, gyroscopes, compasses, touch sensors, volume buttons, vibrators, speakers, batteries, a data processor or controller, a memory device, and a display device. The SmartController can be configured to be held in a hand of a user, worn by the user, or in proximity of the user. In operation, the SmartController can track a user's body positions and movements that include, but are not limited to, positions and movements of: hands, arms, head, neck, legs, and feet. An example embodiment is illustrated in FIGS. 48 and 49.

Referring now to FIGS. 48 and 49, an example embodiment of the SmartController 900 is shown in combination with a digital eyewear device 910 to measure the positional, rotational, directional, and movement data of its user and their corresponding body gestures and movements. The technology implemented in an example embodiment of the SmartController 900 uses a software module to combine orientation data, movement data, and image recognition data, upon which the software module performs data processing to generate control data output for manipulating the VR/AR environment visualized by the digital eyewear device 910. In an example embodiment of the SmartController 900, the on-board hardware components of the SmartController 900 can include a gyroscope, an accelerometer, a compass, a data processor or controller, a memory device, and a display device. In the example embodiment, the hardware components of the digital eyewear device 910 can include a camera or image capturing device, a data processor or controller, a memory device, and a display or VR/AR rendering device. The on-board devices of the SmartController 900 can generate data sets, such as image data, movement data, speed and acceleration data, and the like, that can be processed by the SmartController 900 software module, executed by the on-board data processor or controller, to calculate the user's orientation data, movement data, and image recognition data for the eyewear system 910 environment. With the gyroscope, the accelerometer, and the compass, the SmartController 900 can determine its absolute orientation and position in the real world. The SmartController 900 can apply this absolute orientation and position data to enable the SmartController 900 user to control a software (virtual) object or character in the eyewear system 910 environment with three degrees of freedom (i.e., rotation about the x, y, and z axes). In an example embodiment, the data processing performed by the SmartController 900 software module to control a virtual object with three degrees of freedom in the eyewear system 910 environment can include the following calibration or orientation operations:
1. The execution of the SmartController 900 software module causes the SmartController 900 to use the data provided by the on-board accelerometer to determine the absolute down vector (gravity) as reference (−Y).
2. The execution of the SmartController 900 software module causes the SmartController 900 to use the data provided by the on-board compass to determine the absolute North vector as reference (Z).
3. The execution of the SmartController 900 software module causes the SmartController 900 to use the data provided by the on-board gyroscope to determine the rotation data from the reference vectors (−Y) and (Z) generated in operations 1 and 2 set forth above.
4. Because the reference vectors (−Y) and (Z) are absolute, the execution of the SmartController 900 software module can cause the SmartController 900 to calibrate the readings from the on-board gyroscope, which are initially not absolute, to absolute values. The reference vectors (−Y) and (Z) and related calibration readings can be used to generate a set of reference data associated with the SmartController 900 calibration and orientation.

In an example embodiment during normal operation, the execution of the SmartController 900 software module can cause the SmartController 900 to display a unique pattern as an optical marker 902 on the on-board display device of the SmartController 900. In the example embodiment shown in FIGS. 48 and 49, the optical marker 902 or pattern “A” is displayed on the SmartController 900 display device. It will be apparent to those of ordinary skill in the art in view of the disclosure herein that other forms of optical markers, images, or patterns can be similarly displayed as an optical marker 902 on the on-board display device of the SmartController 900. The optical marker 902 shown in FIGS. 48 and 49 serves a similar purpose in comparison with the optical marker 24 shown in FIGS. 10 and 17 through 26 and described above. In an example embodiment, the SmartController 900 itself can serve as a tracking device with a similar purpose in comparison to the tracking device 20 as described above. When the optical marker 902 displayed on the SmartController 900 is within the field of view of the eyewear system 910 camera as shown in FIG. 48, the execution of a software module of a tracking subsystem in the eyewear system 910 by the data processor or controller in the eyewear system 910 can scan for and capture an image of the optical marker 902 using the camera or other image capturing device/subsystem of the eyewear system 910. The execution of an image recognition software module of the tracking subsystem in the eyewear system 910 can cause the eyewear system 910 to determine the positional and the rotational data of the optical marker 902 relative to the eyewear system 910. In a particular embodiment, the SmartController 900 can also be configured to wirelessly transmit positional and/or movement data and/or the set of reference data to the eyewear system 910 as well. In an example embodiment, because the eyewear device 910 is fixed on the user's head and the SmartController 900 is held in the user's hand within the field of view of the eyewear system 910 camera, the eyewear system 910 software with support of the SmartController 900 software can determine the position and movement of the user's hand relative to the eyewear system 910. As a result, the eyewear system 910 software can display corresponding position and movement of virtual objects in the VR/AR environment displayed by the eyewear system 910. Thus, physical movement of the SmartController 900 by the user can cause corresponding virtual movement of virtual objects in the VR/AR environment displayed by the eyewear system 910.

In an example embodiment, the data processing operations performed by the eyewear system 910 software with support of the SmartController 900 software is presented below:
1. Using the display device of the SmartController 900, the optical marker 902 can be displayed on the SmartController 900 as held in the hand or in proximity of a user.
2. Using an image feed provided by the camera (e.g., image capturing subsystem) of the eyewear system 910, the eyewear system 910 software (or the tracking subsystem implemented therein) can receive and process the image feed, which represents a field of view of the camera of the eyewear system 910. The tracking subsystem of the eyewear system 910 can scan the field of view for a unique pattern corresponding to the optical marker 902. At least a portion of the scanned field of view can be received and retained as captured marker image data from the image capturing subsystem of the eyewear system 910.
3. If the optical marker 902 is present in at least a portion of the image feed, the tracking subsystem of the eyewear system 910 software can compare an untransformed reference pattern image corresponding to the optical marker 902 (the reference marker image data) with the image of the optical marker 902 found in the eyewear system 910 camera feed (the captured marker image data).
4. The tracking subsystem of the eyewear system 910 software can use the comparison of the reference marker image data with the captured marker image data to generate a transformation matrix (T_{controller}) corresponding to the position and orientation of the SmartController 900 relative to the eyewear system 910.
5. The tracking subsystem of the eyewear system 910 software can also use the comparison of the reference marker image data with the captured marker image data to generate a transformation matrix (T_{eye}) corresponding to the position and orientation of the eyewear system 910 itself.
6. In the rendered virtual environment of eyewear system 910, a virtual rendering subsystem of the eyewear system 910 software can render the virtual SmartController as well as the user's virtual hand in the virtual environment using the transformation matrix generated as follows: T_{controller}×T_{eye}. As a result, the virtual rendering subsystem of the eyewear system 910 software can display corresponding position and movement of virtual objects in the VR/AR environment displayed by the eyewear system 910. Thus, the virtual rendering subsystem can generate an action in a virtual environment, the action corresponding to the transformation matrix. In this manner, physical movement or action on the physical SmartController 900 by the user can cause corresponding virtual movement or action on virtual objects in the VR/AR environment as displayed or rendered by the eyewear system 910.

In example embodiments, the eyewear system 910 software and/or the SmartController 900 software can include display, image capture, pattern recognition, and/or image processing modules that can recognize the spatial frequency (e.g., pattern, shape, etc.), the light wave frequency (e.g., color), and the temporal frequency (e.g., flickering at certain frequency). In these various embodiments, the optical marker 902 can be presented and recognized in a variety of ways including recognition based on spatial frequency, light wave frequency, temporal frequency, and/or combinations thereof.

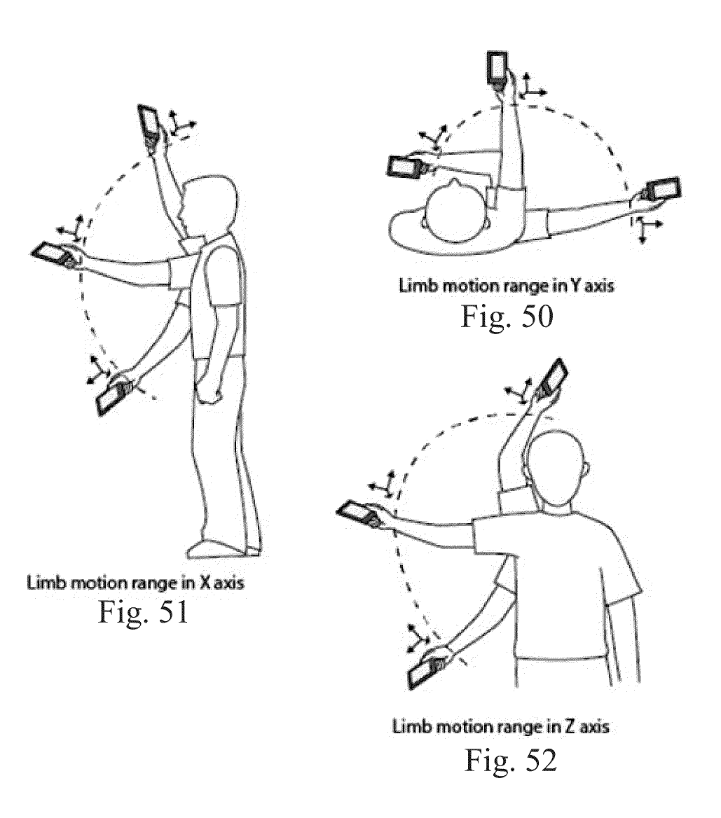

Referring to FIG. 49, when the optical marker 902 is not present in the field of view of the eyewear system 910, the eyewear system 910 software can estimate the position of the SmartController 900 using the acceleration data, orientation data, and the anatomical range of human locomotion. This position estimation is described in more detail below in connection with FIGS. 50 through 52.

Referring now to FIGS. 50 through 52, an example embodiment can estimate the position of the SmartController 900 using the acceleration data, orientation data, and the anatomical range of human locomotion. In an example embodiment, the eyewear system 910 software and/or the SmartController 900 software can use the acceleration data from the on-board accelerometer of the SmartController 900 to estimate the movements and positions of its user's body in the eyewear system 910 environment. For example, the eyewear system 910 software can move its user's virtual hand and arm in the eyewear system 910 virtual environment with the same acceleration as measured by the physical SmartContoller 900. The eyewear system 910 software and/or the SmartController 900 software can use noise reduction processes to enhance the accuracy of the movement and position estimations. In some cases, the acceleration readings may be different from device to device, which may cause a reduction in the accuracy of the movement and position estimations.

As shown in FIGS. 50 through 52, the eyewear system 910 software and/or the SmartController 900 software can use the orientation data and knowledge of human anatomy to generate a better estimation of the user's movement and position in the eyewear system 910 environment. As shown in FIGS. 50 through 52, the human hand and arm have their natural poses and limits on motion. The eyewear system 910 software and/or the SmartController 900 software can take these natural human postures and ranges of movement into consideration when calibrating movement and position estimates.

Over time, these SmartController 900 movement and position estimates will become more and more unsynchronized with the actual position of the SmartController 900. However, whenever the SmartController 900 is brought back into the field of view of the eyewear system 910 camera, the eyewear system 910 software can re-calibrate the SmartController 900 positional data with the absolute position determined via the optical marker 902 recognition process as described above. The eyewear system 910 software and/or the SmartController 900 software can request or prompt the user via a user interface indication to perform an action to calibrate his or her SmartController 900. This user prompt can be a direct request (e.g., show calibration instructions to the user) or an indirect request (e.g., request the user to perform an aiming action, which requires his or her hand to be in front of his or her eye and within the field of view).

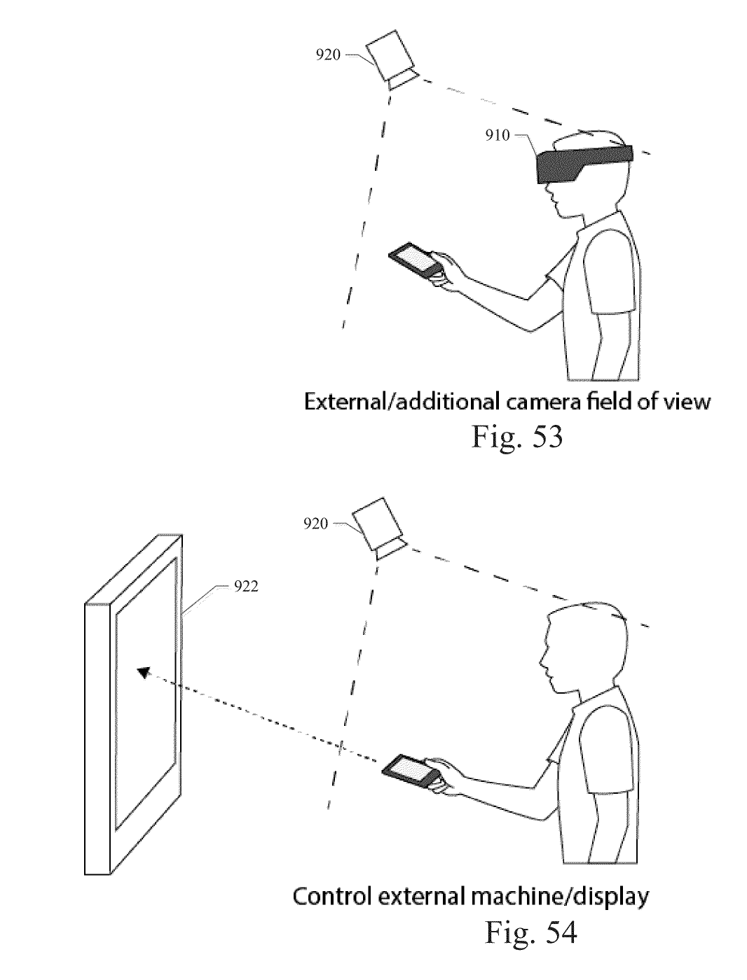

Referring now to FIG. 53 and another example embodiment, the eyewear system 910 software and/or the SmartController 900 software can couple with one or more external cameras 920 to increase the coverage area where the SmartController 900, and the optical marker 902 displayed thereon, is tracked. The image feed from the external camera 920 can be received wirelessly by eyewear system 910 software and/or the SmartController 900 software using conventional techniques. As shown in FIG. 53, for example, using the eyewear system 910 camera in combination with the external camera 920 as shown can significantly increase the field of view in which the SmartController 900 can accurately function.

In another example embodiment shown in FIG. 54, the SmartController 900 can be tracked using the image feed from an external camera 920 and the user's motion input can be reflected on an external display device 922. With this configuration as shown in FIG. 54, users can control not only 3D objects rendered in the virtual environment of eyewear system 910, but users can also control external machines or displays, such as external display device 922. For example, using the techniques described herein, a user can use the SmartController 900 to control appliances, vehicles, holograms or holographic devices, robots, digital billboards in public areas, and the like. The various embodiments described herein can provide close to 100% accurate precision in tracking a user's positional and orientational data under a variety of lighting conditions and environments.

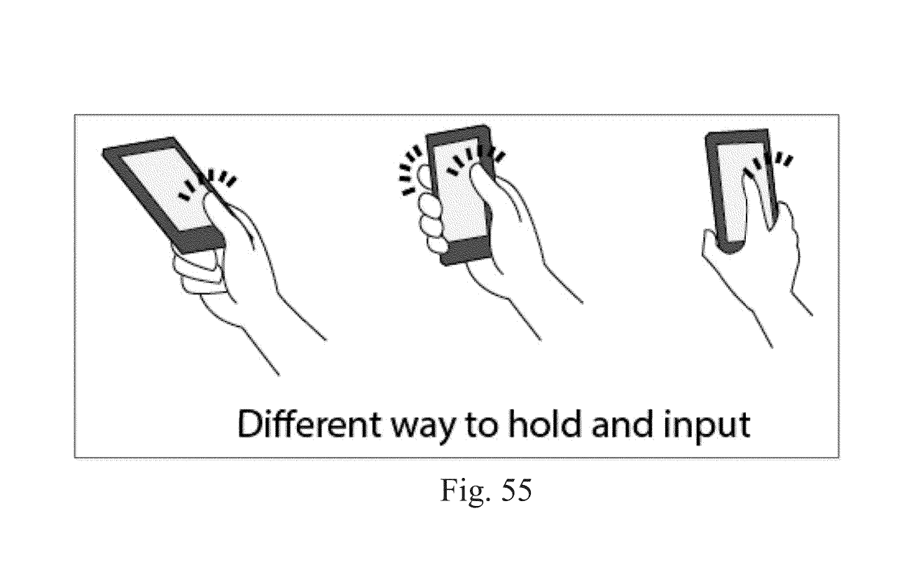

Referring now to FIG. 55, a variety of methods can be used to provide user input via the SmartController 900. Depending on the context and application of the embodiments described herein, the user can hold the SmartController 900 differently to perform different tasks. The SmartController 900 software can use all input modules, input devices, or input methods available on the SmartController 900 as user input methods. In various example embodiments, these input modules, input devices, or input methods can include, but are not limited to: touchscreen, buttons, cameras, and the like. A list of actions a user can take based on these input methods in an example embodiment are listed below:
1. Interact with the screen (tap, drag, swipe, draw, etc.)
2. Click buttons (volume button, etc.)
3. Gesture in front of camera
4. Cover the light sensor
5. Physical movements

In a particular embodiment, a user may want to see the display screen of the SmartController 900 in his or her eyewear system 910 environment. For example, the user may want to see a virtual visualization of the user typing on a virtual screen keyboard corresponding to the SmartController 900. In this case, the SmartController 900 software can wirelessly broadcast data indicative of the content of the display screen of the SmartController 900 to the display device of the eyewear system 910 environment. In this way, the user is allowed to interact with the display screen of the SmartController 900 via the eyewear system 910 environment in an intuitive manner.

In another example embodiment, the SmartController 900 software can also use the available haptic modules or haptic devices (e.g., vibrators) of the SmartController 900 to provide physical or tactile feedback to the user. For example, when the user's virtual hand touches a virtual object in the eyewear system 910 environment, the SmartController 900 software can instruct the available haptic modules or haptic devices of the SmartController 900 to vibrate, thereby sending a physical or tactile stimulus to the user as related to the touching of the virtual object in the eyewear system 910 environment.

In another example embodiment, the SmartController 900 can be configured to contain biometric sensors (e.g., fingerprint reader, retina reader, voice recognition, etc.), which can be used to verify the user's identity in the real world environment in addition to verifying the user's identity in the virtual environment of the eyewear system 910. The user identity verification can be used to enhance the protection of the user's data, the user's digital identity, the user's virtual assets, and the user's privacy.

In the various example embodiments described herein, the SmartController 900 can be configured as a hand-held mobile device, mobile phone, or smartphone (e.g., iPhone). The SmartController 900 software described herein can be implemented at least in part as an installed application or app on the SmartController 900 (e.g., smartphone). In other embodiments, the SmartController 900 can be configured as a personal computer (PC), a laptop computer, a tablet computing system, a Personal Digital Assistant (PDA), a cellular telephone, a web appliance, a wearable electronic device, or the like. As described above, the SmartController 900 can serve as the tracking device 20 as also described above. Further, the digital eyewear system 910 and the virtual environment rendered thereby can be implemented as a device similar to the user device 12 as described above. The data converter 16 and image capturing device 18 as described above can also be integrated into or with the digital eyewear system 910 and used with the SmartController 900 as described above. Finally, the external display device 922 as described above can be implemented as a personal computer (PC), a laptop computer, a tablet computing system, a Personal Digital Assistant (PDA), a cellular telephone, a web appliance, a wearable electronic device, an appliance, a vehicle, a hologram or holographic generator, a robot, a digital billboard, or other electronic machine or device.

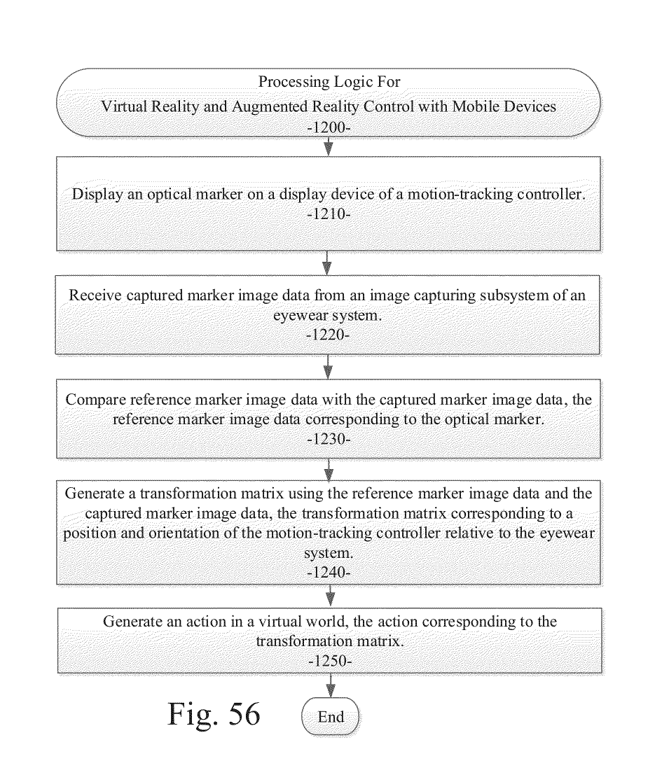

Referring now to FIG. 56, a processing flow diagram illustrates an example embodiment of a method 1200 as described herein. The method 1200 of an example embodiment includes: displaying an optical marker on a display device of a motion-tracking controller (processing block 1210); receiving captured marker image data from an image capturing subsystem of an eyewear system (processing block 1220); comparing reference marker image data with the captured marker image data, the reference marker image data corresponding to the optical marker (processing block 1230); generating a transformation matrix using the reference marker image data and the captured marker image data, the transformation matrix corresponding to a position and orientation of the motion-tracking controller relative to the eyewear system (processing block 1240); and generating an action in a virtual world, the action corresponding to the transformation matrix (processing block 1250).

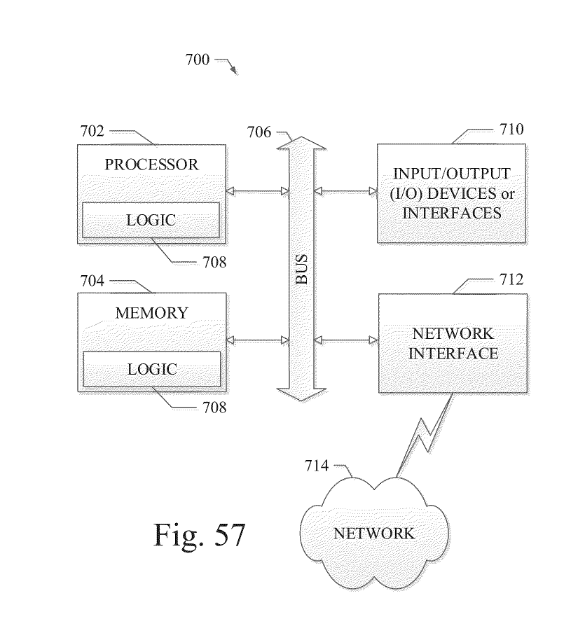

FIG. 57 shows a diagrammatic representation of a machine in the example form of an electronic device, such as a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip [SoC], general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display, an audio jack, and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

With general reference to notations and nomenclature used herein, the description presented herein may be disclosed in terms of program procedures executed on a computer or a network of computers. These procedural descriptions and representations may be used by those of ordinary skill in the art to convey their work to others of ordinary skill in the art.

A procedure is generally conceived to be a self-consistent sequence of operations performed on electrical, magnetic, or optical signals capable of being stored, transferred, combined, compared, and otherwise manipulated. These signals may be referred to as bits, values, elements, symbols, characters, terms, numbers, or the like. It should be noted, however, that all of these and similar terms are to be associated with the appropriate physical quantities and are merely convenient labels applied to those quantities. Further, the manipulations performed are often referred to in terms such as adding or comparing, which operations may be executed by one or more machines. Useful machines for performing operations of various embodiments may include general-purpose digital computers or similar devices. Various embodiments also relate to apparatus or systems for performing these operations. This apparatus may be specially constructed for a purpose, or it may include a general-purpose computer as selectively activated or reconfigured by a computer program stored in the computer. The procedures presented herein are not inherently related to a particular computer or other apparatus. Various general-purpose machines may be used with programs written in accordance with teachings herein, or it may prove convenient to construct more specialized apparatus to perform methods described herein.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a motion-tracking controller configured to be held by a user, the motion-tracking controller including a display device for displaying an optical marker; and
an eyewear system configured to be worn by the user, the eyewear system including:
a data processor;
an image capturing subsystem;
a tracking subsystem in data communication with the data processor and the image capturing subsystem, the tracking subsystem including reference marker image data corresponding to the optical marker, the tracking subsystem being configured to:
receive captured marker image data from the image capturing subsystem;
compare the reference marker image data with the captured marker image data;
generate a transformation matrix using the reference marker image data and the captured marker image data, the transformation matrix corresponding to a position and orientation of the motion-tracking controller relative to the eyewear system; and
a virtual rendering subsystem in data communication with the data processor and the tracking subsystem, the virtual rendering subsystem being configured to generate an action in a virtual world, the action corresponding to the transformation matrix.

2. The system of claim 1 wherein the motion-tracking controller is a device of a type from the group consisting of: a hand-held mobile device, a mobile phone, and a smartphone.

3. The system of claim 1 wherein the motion-tracking controller includes an accelerometer, a gyroscope, and a compass.

4. The system of claim 1 wherein the motion-tracking controller being further configured to determine its absolute orientation and position in the real world.

5. The system of claim 1 wherein the tracking subsystem being further configured to scan a field of view of the image capturing subsystem for a unique pattern corresponding to the optical marker.

6. The system of claim 1 wherein the tracking subsystem being further configured to generate a second transformation matrix using the reference marker image data and the captured marker image data, the second transformation matrix corresponding to a position and orientation of the eyewear system.

7. The system of claim 1 wherein the tracking subsystem being further configured to recognize the reference marker image data as a spatial frequency, a light wave frequency, or a temporal frequency.

8. The system of claim 1 wherein the tracking subsystem being further configured to estimate a position of the motion-tracking controller if the motion-tracking controller is out of a field of view of the image capturing subsystem.

9. The system of claim 1 wherein the action in the virtual world is the movement or manipulation of a virtual object or the manipulation of a virtual user interface.

10. The system of claim 1 wherein the action in the virtual world corresponds to control of a real world device.

11. A method comprising:
displaying an optical marker on a display device of a motion-tracking controller;
receiving captured marker image data from an image capturing subsystem of an eyewear system;
comparing reference marker image data with the captured marker image data, the reference marker image data corresponding to the optical marker;
generating a transformation matrix using the reference marker image data and the captured marker image data, the transformation matrix corresponding to a position and orientation of the motion-tracking controller relative to the eyewear system; and
generating an action in a virtual world, the action corresponding to the transformation matrix.

12. The method of claim 11 wherein the motion-tracking controller is a device of a type from the group consisting of: a hand-held mobile device, a mobile phone, and a smartphone.

13. The method of claim 11 wherein the motion-tracking controller includes an accelerometer, a gyroscope, and a compass.

14. The method of claim 11 including determining the absolute orientation and position of the motion-tracking controller in the real world.

15. The method of claim 11 including scanning a field of view of the image capturing subsystem for a unique pattern corresponding to the optical marker.

16. The method of claim 11 including generating a second transformation matrix using the reference marker image data and the captured marker image data, the second transformation matrix corresponding to a position and orientation of the eyewear system.

17. The method of claim 11 including recognizing the reference marker image data as a spatial frequency, a light wave frequency, or a temporal frequency.

18. The method of claim 11 including estimating a position of the motion-tracking controller if the motion-tracking controller is out of a field of view of the image capturing subsystem.

19. A non-transitory machine-useable storage medium embodying instructions which, when executed by a machine, cause the machine to:
receive captured marker image data from an image capturing subsystem of an eyewear system;
compare reference marker image data with the captured marker image data, the reference marker image data corresponding to an optical marker displayed on a display device of a motion-tracking controller;
generate a transformation matrix using the reference marker image data and the captured marker image data, the transformation matrix corresponding to a position and orientation of the motion-tracking controller relative to the eyewear system; and
generate an action in a virtual world, the action corresponding to the transformation matrix.

20. The instructions embodied in the machine-useable storage medium of claim 19 wherein the action in the virtual world is the movement or manipulation of a virtual object or the manipulation of a virtual user interface.
